(19) United States
(12) Patent Application Publication
(10) Pub. No.: US 2022/0413889 A1
(43) Pub. Date: Dec. 29, 2022

(54) VIRTUAL-SUBSYSTEM-MIGRATION VALIDATOR

(71) Applicant: VMWARE,INC, Palo Alto, CA (US)

(72) Inventors: DIPESH BHATEWARA, Pune (IN); PRASHANT SHELKE, Pune (IN); PRASHANT SUTAR, Pune (IN); DASHMEET KAUR AJMANI, Pune (IN); SHUBHAM MUKKAWAR, Pune (IN)

(21) Appl. No.: 17/402,663

(22) Filed: Aug. 16, 2021

(30) Foreign Application Priority Data
Jun. 28, 2021 (IN) 202141028955

(51) Int. Cl. G06F 9/455

(52) U.S. Cl. CPC G06F 9/45558; G06F 2009/4557; G06F 2009/45595

(57) ABSTRACT

The current document is directed to methods and subsystems that validate migration of a virtualized subsystem from a first implementation and/or version to a second implementation and/or version carried out by a semi-automated or automated migration process. Virtualized-subsystem migrations allow a distributed computer system to access new and improved facilities and capabilities provided by a new virtualized-subsystem implementation and/or version. However, there are risks associated with semi-automated and automated migration processes. Independent validation of a migration by the currently disclosed methods and systems ameliorates these risks.

### RELATED APPLICATIONS

Benefit is claimed under 35 U. S.C. 119(a)-(d) to Foreign Application Serial No. 202141028955 filed in India entitled “VIRTUAL-SUBSYSTEM-MIGRATION VALIDATOR”, on Jun. 28, 2021, by VMware, Inc., which is herein incorporated in its entirety by reference for all purposes.

### TECHNICAL FIELD

The current document is directed to distributed-computer-systems and, in particular, to methods and subsystems that validate migration of a virtualized subsystem from a first implementation and/or version to a second implementation and/or version.

### BACKGROUND

During the past seven decades, electronic computing has evolved from primitive, vacuum-tube-based computer systems, initially developed during the 1940s, to modern electronic computing systems in which large numbers of multi-processor servers, work stations, and other individual computing systems are networked together with large-capacity data-storage devices and other electronic devices to produce geographically distributed computing systems with hundreds of thousands, millions, or more components that provide enormous computational bandwidths and data-storage capacities. These large, distributed computing systems are made possible by advances in computer networking, distributed operating systems and applications, data-storage appliances, computer hardware, and software technologies. However, despite all of these advances, the rapid increase in the size and complexity of computing systems has been accompanied by numerous scaling issues and technical challenges, including technical challenges associated with communications overheads encountered in parallelizing computational tasks among multiple processors, component failures, and distributed-system management. As new distributed-computing technologies are developed, and as general hardware and software technologies continue to advance, the current trend towards ever-larger and more complex distributed computing systems appears likely to continue well into the future.

As the complexity of distributed computing systems has increased, the management and administration of distributed computing systems has, in turn, become increasingly complex, involving greater computational overheads and significant inefficiencies and deficiencies. In fact, many desired management-and-administration functionalities are becoming sufficiently complex to render traditional manual approaches to management and administration of distributed computing systems impractical, from a time and cost standpoint, and even from a feasibility standpoint. Therefore, designers and developers are seeking to implement semi-automated and automated management-and-administration facilities and functionalities. As one example, it is often necessary to update complex components of distributed computer systems as new technologies become available, but, due to the complexities of update operations in modern computational environments, manual-update processes are often no longer practical and validation of updates performed by semi-automated and automated processes may be difficult or infeasible.

### SUMMARY

The current document is directed to methods and subsystems that validate migration of a virtualized subsystem from a first implementation and/or version to a second implementation and/or version. Virtualized-subsystem migrations allow a distributed computer system to access new and improved facilities and capabilities provided by a new virtualized-subsystem implementation and/or version, and effective and efficient migrations are needed to minimize update overheads and post-migration problems. Because of the complexity of many virtualized subsystems and the large amount of data that may need to be updated in order to effect a virtualized-subsystem migration, and because of the lack of data-update-validation facilities in currently available virtualized-sub system-migration tools, currently available virtualized-subsystem-migration tools often do not provide sufficient validation capabilities to offset the risks associated with virtualized-subsystem migration. However, failure to carry out migrations can, in the long term, itself represent a significant risk that increases with time. Independent validation of a migration by the currently disclosed methods and systems ameliorates these risks.

### BRIEF DESCRIPTION OF THE DRAWINGS

FIG. 1 provides a general architectural diagram for various types of computers.

FIG. 2 illustrates an Internet-connected distributed computing system.

FIG. 3 illustrates cloud computing.

FIG. 4 illustrates generalized hardware and software components of a general-purpose computer system, such as a general-purpose computer system having an architecture similar to that shown in FIG. 1.

FIGS. 5A-D illustrate several types of virtual machine and virtual-machine execution environments.

FIG. 6 illustrates an OVF package.

FIG. 7 illustrates virtual data centers provided as an abstraction of underlying physical-data-center hardware components.

FIG. 8 illustrates virtual-machine components of a VI-management-server and physical servers of a physical data center above which a virtual-data-center interface is provided by the VI-management-server.

FIG. 9 illustrates a cloud-director level of abstraction.

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds.

FIG. 11 illustrates the Open Systems Interconnection model (“OSI model”) that characterizes many modern approaches to implementation of communications systems that interconnect computers.

FIGS. 12A-B illustrate a layer-2-over-layer-3 encapsulation technology on which virtualized networking can be based.

FIG. 13 illustrates virtualization of two communicating servers.

FIG. 14 illustrates a virtual distributed computer system based on one or more distributed computer systems.

FIG. 15 illustrates components of several implementations of a virtual network within a distributed computing system.

FIG. 16 illustrates two different versions and/or implementations of one type of virtual network.

FIG. 17 illustrates in-place migration of a virtual-network subsystem within a virtual distributed computer system from NSX-V to NSX-T

FIG. 18 lists examples of the many types of virtual-network configuration data that describe the configuration and state of a virtual-network subsystem.

FIGS. 19A-B provide control-flow diagrams that illustrate an NSX-V-to-NSX-T-migration process using a migration coordinator that facilitates migration of a virtual-network subsystem within a virtual distributed computer system from NSX-V to NSX-T.

FIG. 20 provides a high-level illustration of the currently disclosed virtual-subsystem-migration validator within an NSX-V to NSX-T migration context.

FIG. 21 illustrates one component of one implementation of the currently disclosed virtual-subsystem-migration validator.

FIG. 22 illustrates a second component of one implementation of the currently disclosed virtual-sub system-migration validator.

FIG. 23 illustrates a third component of one implementation of the currently disclosed virtual-subsystem-migration validator.

FIGS. 24A-B illustrates operation of the currently disclosed virtual-subsystem-migration validator.

FIGS. 25A-C illustrates various relational-database tables that are used in one implementation of the currently disclosed methods and systems for converting configuration files to corresponding intents.

FIGS. 26A-B illustrates the configuration-to-intent conversion process carried out by the C→I/I→C component discussed above with reference to FIG. 21.

FIG. 27 illustrates the intent-to-configuration conversion process carried out by the C→I/I→C component discussed above with reference to FIG. 21.

FIG. 28 illustrates differences between configuration files and intents.

### DETAILED DESCRIPTION

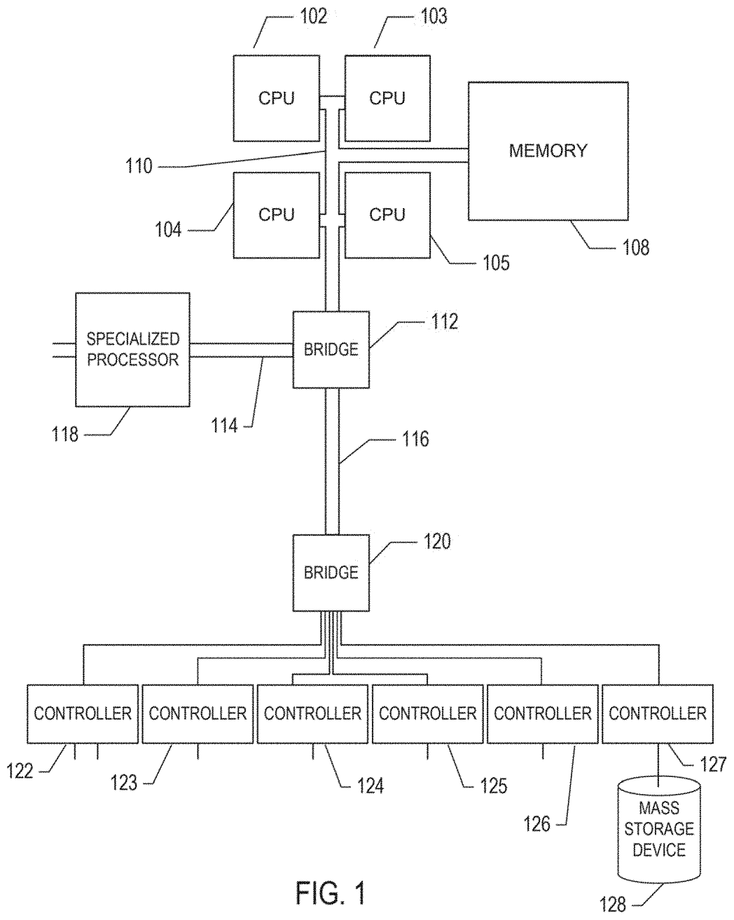

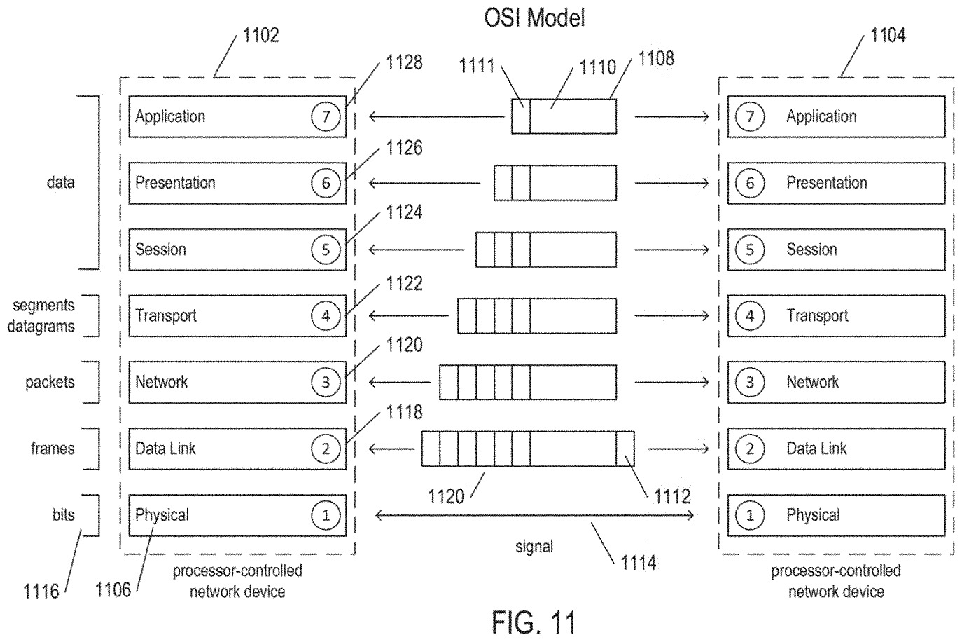

The current document is directed to methods and subsystems that validate migration of a virtualized subsystem from a first implementation and/or version to a second implementation and/or version. In a first subsection, below, a detailed description of computer hardware, complex computational systems, and virtualization is provided with reference to FIGS. 1-10. In a second subsection, the currently disclosed methods and systems are discussed with reference to FIGS. 11-28.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

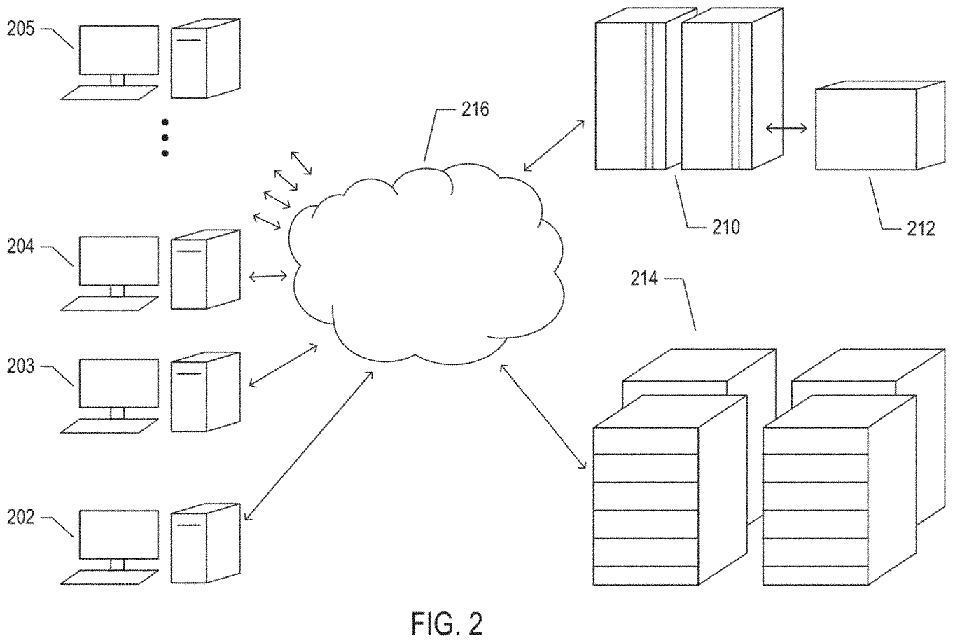

FIG. 2 illustrates an Internet-connected distributed computing system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

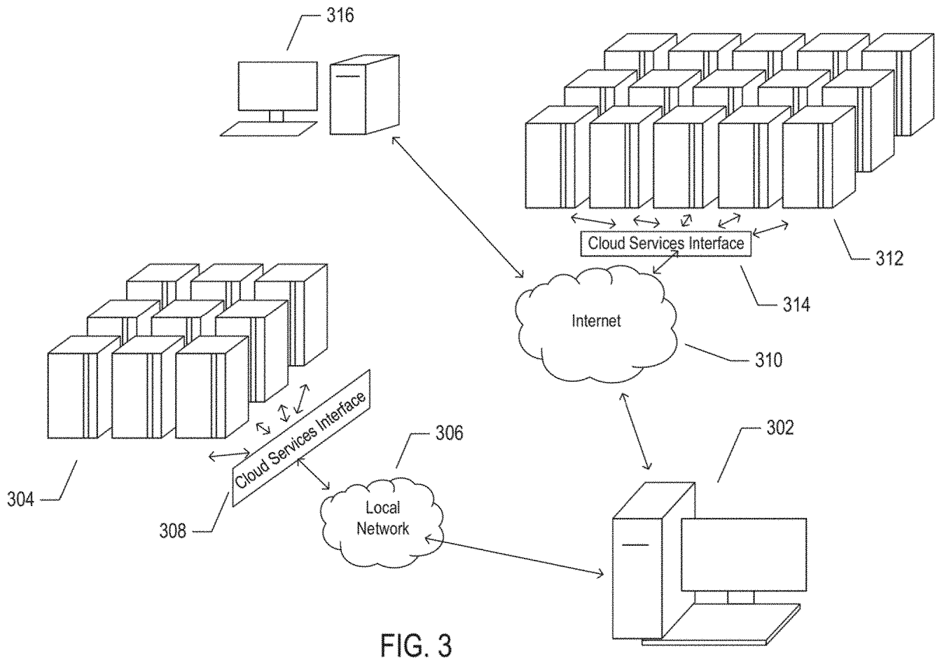

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

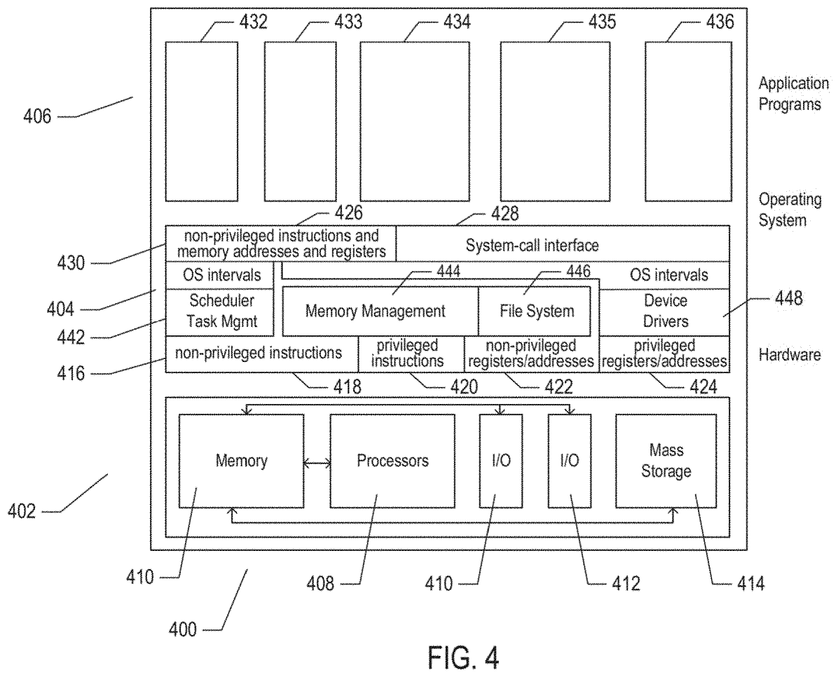

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computing system for high-availability, fault-tolerance, and load-balancing purposes. The problems are even greater in heterogeneous distributed computing systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

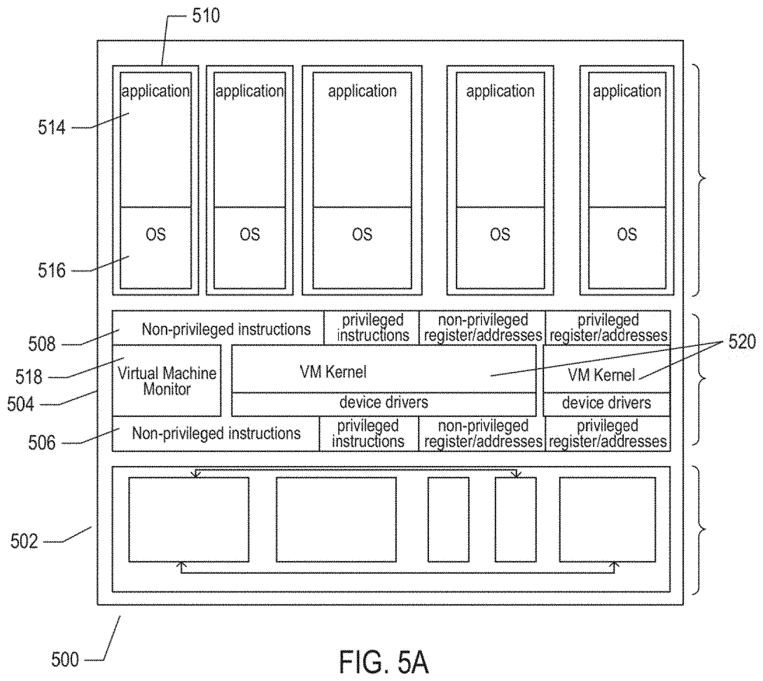

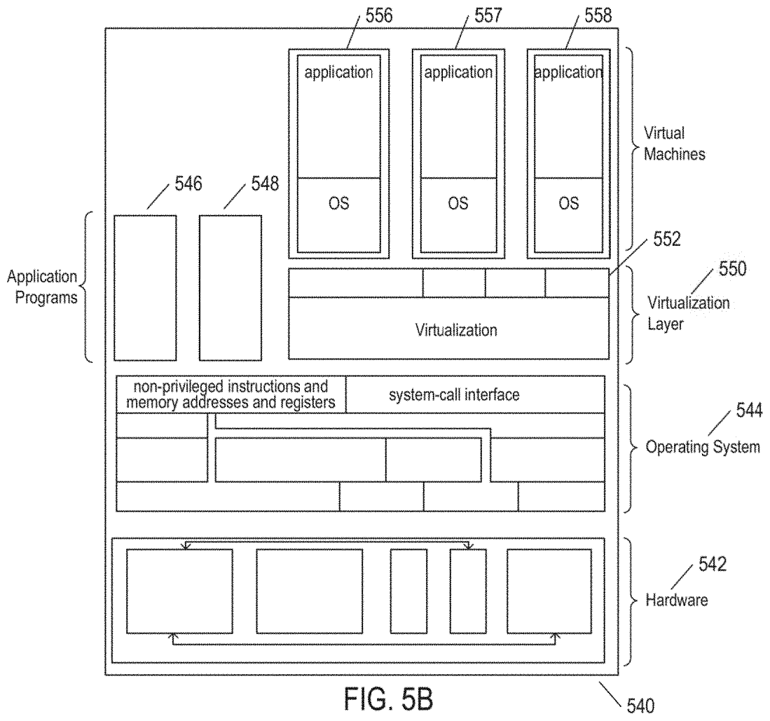

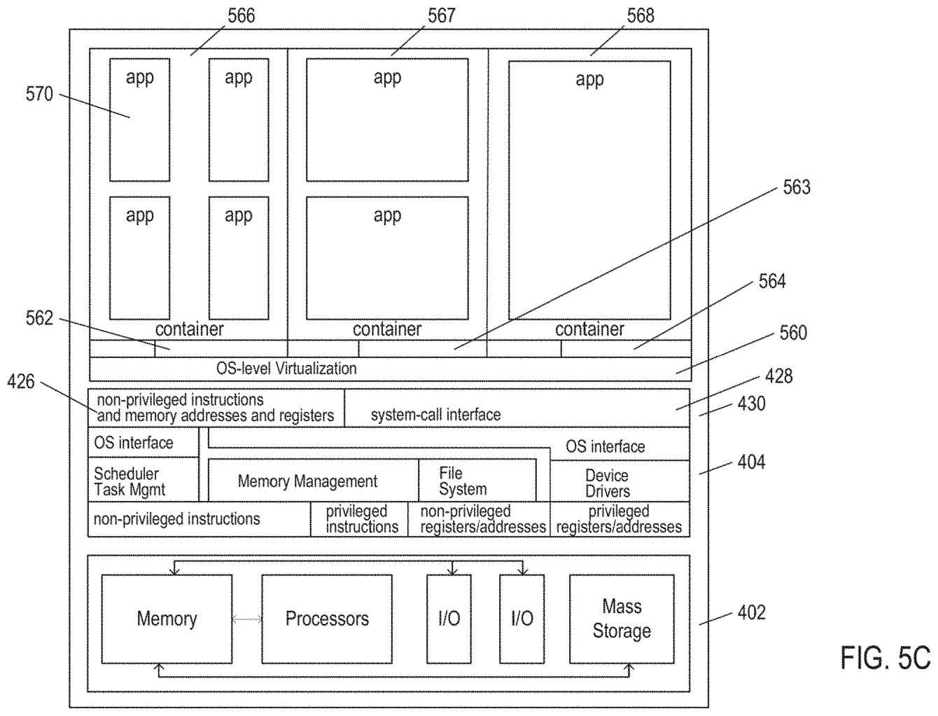

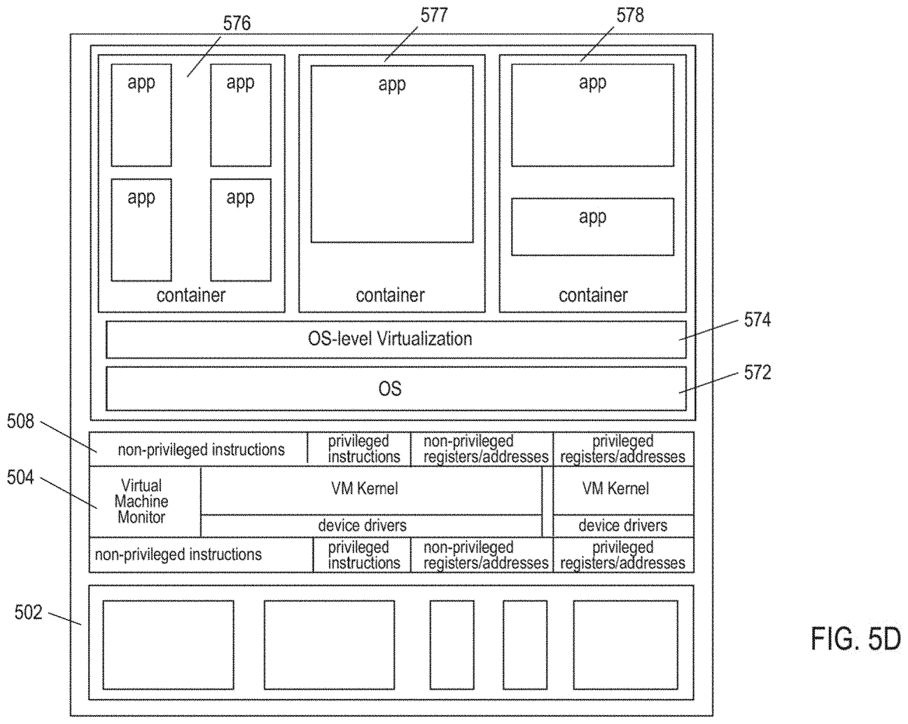

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-D illustrate several types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

While the traditional virtual-machine-based virtualization layers, described with reference to FIGS. 5A-B, have enjoyed widespread adoption and use in a variety of different environments, from personal computers to enormous distributed computing systems, traditional virtualization technologies are associated with computational overheads. While these computational overheads have been steadily decreased, over the years, and often represent ten percent or less of the total computational bandwidth consumed by an application running in a virtualized environment, traditional virtualization technologies nonetheless involve computational costs in return for the power and flexibility that they provide. Another approach to virtualization is referred to as operating-system-level virtualization (“OSL virtualization”). FIG. 5C illustrates the OSL-virtualization approach. In FIG. 5C, as in previously discussed FIG. 4, an operating system 404 runs above the hardware 402 of a host computer. The operating system provides an interface for higher-level computational entities, the interface including a system-call interface 428 and exposure to the non-privileged instructions and memory addresses and registers 426 of the hardware layer 402. However, unlike in FIG. 5A, rather than applications running directly above the operating system, OSL virtualization involves an OS-level virtualization layer 560 that provides an operating-system interface 562-564 to each of one or more containers 566-568. The containers, in turn, provide an execution environment for one or more applications, such as application 570 running within the execution environment provided by container 566. The container can be thought of as a partition of the resources generally available to higher-level computational entities through the operating system interface 430. While a traditional virtualization layer can simulate the hardware interface expected by any of many different operating systems, OSL virtualization essentially provides a secure partition of the execution environment provided by a particular operating system. As one example, OSL virtualization provides a file system to each container, but the file system provided to the container is essentially a view of a partition of the general file system provided by the underlying operating system. In essence, OSL virtualization uses operating-system features, such as name space support, to isolate each container from the remaining containers so that the applications executing within the execution environment provided by a container are isolated from applications executing within the execution environments provided by all other containers. As a result, a container can be booted up much faster than a virtual machine, since the container uses operating-system-kernel features that are already available within the host computer. Furthermore, the containers share computational bandwidth, memory, network bandwidth, and other computational resources provided by the operating system, without resource overhead allocated to virtual machines and virtualization layers. Again, however, OSL virtualization does not provide many desirable features of traditional virtualization. As mentioned above, OSL virtualization does not provide a way to run different types of operating systems for different groups of containers within the same host system, nor does OSL-virtualization provide for live migration of containers between host computers, as does traditional virtualization technologies.

FIG. 5D illustrates an approach to combining the power and flexibility of traditional virtualization with the advantages of OSL virtualization. FIG. 5D shows a host computer similar to that shown in FIG. 5A, discussed above. The host computer includes a hardware layer 502 and a virtualization layer 504 that provides a simulated hardware interface 508 to an operating system 572. Unlike in FIG. 5A, the operating system interfaces to an OSL-virtualization layer 574 that provides container execution environments 576-578 to multiple application programs. Running containers above a guest operating system within a virtualized host computer provides many of the advantages of traditional virtualization and OSL virtualization. Containers can be quickly booted in order to provide additional execution environments and associated resources to new applications. The resources available to the guest operating system are efficiently partitioned among the containers provided by the OSL-virtualization layer 574. Many of the powerful and flexible features of the traditional virtualization technology can be applied to containers running above guest operating systems including live migration from one host computer to another, various types of high-availability and distributed resource sharing, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides flexible and easy scaling and a simple approach to operating-system upgrades and patches. Thus, the use of OSL virtualization above traditional virtualization, as illustrated in FIG. 5D, provides much of the advantages of both a traditional virtualization layer and the advantages of OSL virtualization. Note that, although only a single guest operating system and OSL virtualization layer as shown in FIG. 5D, a single virtualized host system can run multiple different guest operating systems within multiple virtual machines, each of which supports one or more containers.

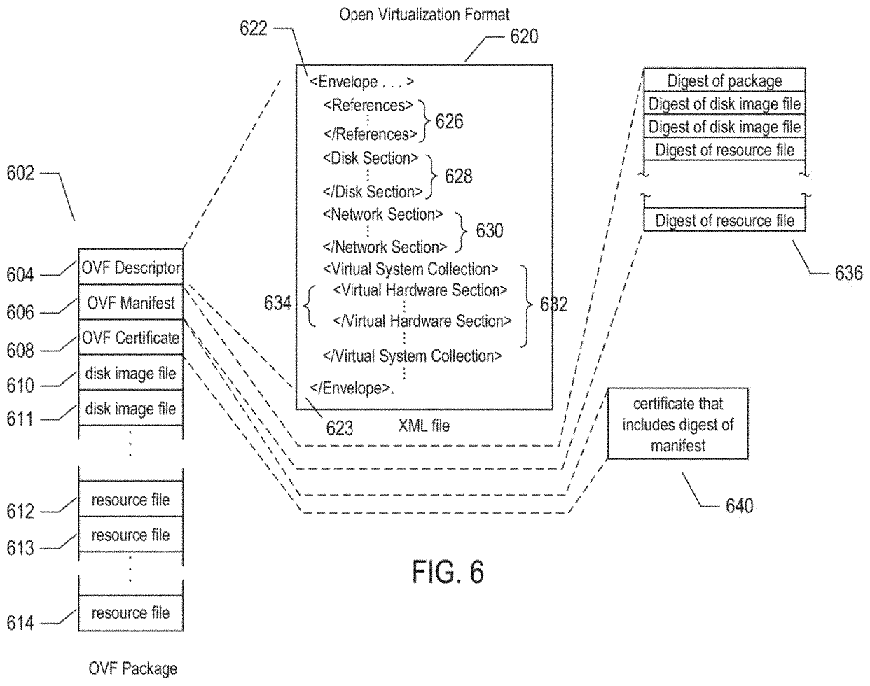

A virtual machine or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a virtual machine within one or more data files. FIG. 6 illustrates an OVF package. An OVF package 602 includes an OVF descriptor 604, an OVF manifest 606, an OVF certificate 608, one or more disk-image files 610-611, and one or more resource files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each virtual machine 634. There are many additional hierarchical levels and elements within a typical OVF descriptor. The OVF descriptor is thus a self-describing XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and resource files 612 are digitally encoded content, such as operating-system images. A virtual machine or a collection of virtual machines encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more virtual machines that is encoded within an OVF package.

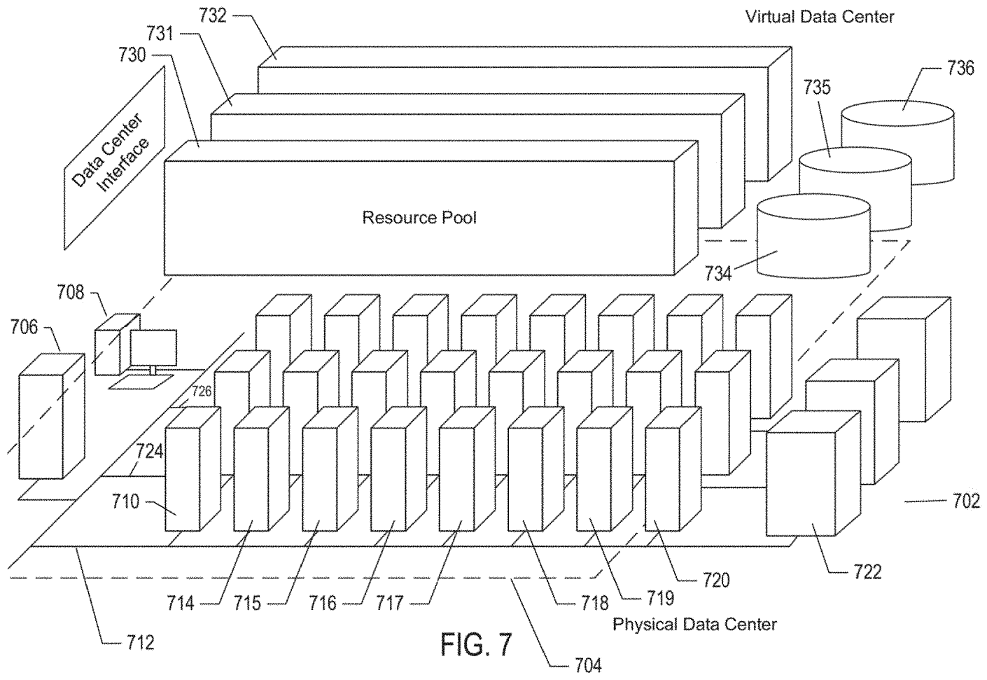

The advent of virtual machines and virtual environments has alleviated many of the difficulties and challenges associated with traditional general-purpose computing. Machine and operating-system dependencies can be significantly reduced or entirely eliminated by packaging applications and operating systems together as virtual machines and virtual appliances that execute within virtual environments provided by virtualization layers running on many different types of computer hardware. A next level of abstraction, referred to as virtual data centers which are one example of a broader virtual-infrastructure category, provide a data-center interface to virtual data centers computationally constructed within physical data centers. FIG. 7 illustrates virtual data centers provided as an abstraction of underlying physical-data-center hardware components. In FIG. 7, a physical data center 702 is shown below a virtual-interface plane 704. The physical data center consists of a virtual-infrastructure management server (“VI-management-server”) 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple virtual machines. Different physical data centers may include many different types of computers, networks, data-storage systems and devices connected according to many different types of connection topologies. The virtual-data-center abstraction layer 704, a logical abstraction layer shown by a plane in FIG. 7, abstracts the physical data center to a virtual data center comprising one or more resource pools, such as resource pools 730-732, one or more virtual data stores, such as virtual data stores 734-736, and one or more virtual networks. In certain implementations, the resource pools abstract banks of physical servers directly interconnected by a local area network.

The virtual-data-center management interface allows provisioning and launching of virtual machines with respect to resource pools, virtual data stores, and virtual networks, so that virtual-data-center administrators need not be concerned with the identities of physical-data-center components used to execute particular virtual machines. Furthermore, the VI-management-server includes functionality to migrate running virtual machines from one physical server to another in order to optimally or near optimally manage resource allocation, provide fault tolerance, and high availability by migrating virtual machines to most effectively utilize underlying physical hardware resources, to replace virtual machines disabled by physical hardware problems and failures, and to ensure that multiple virtual machines supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of virtual machines and virtual appliances as well as to provide high-level, distributed functionalities that involve pooling the resources of individual physical servers and migrating virtual machines among physical servers to achieve load balancing, fault tolerance, and high availability.

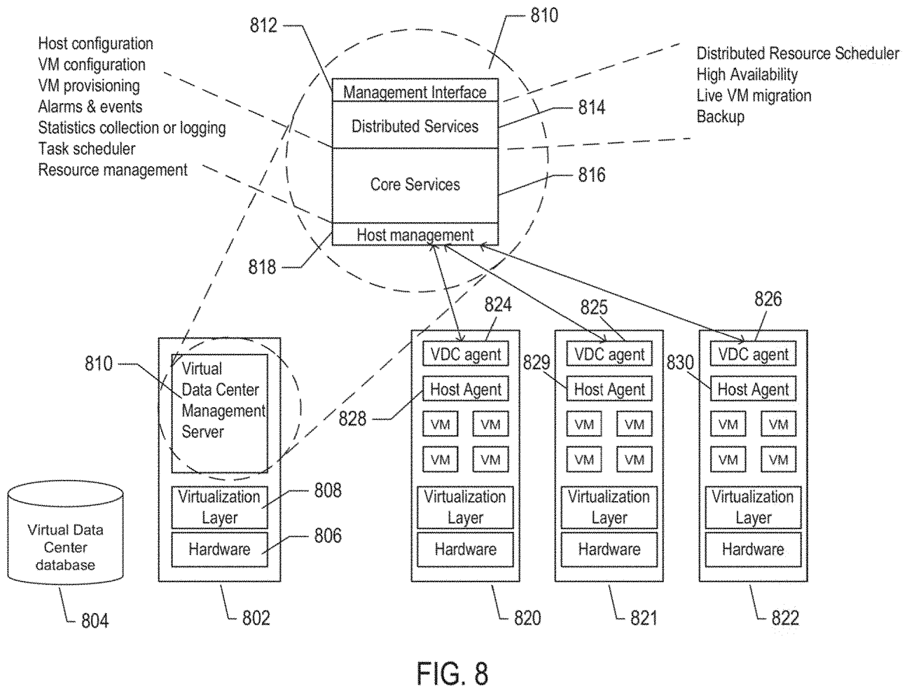

FIG. 8 illustrates virtual-machine components of a VI-management-server and physical servers of a physical data center above which a virtual-data-center interface is provided by the VI-management-server. The VI-management-server 802 and a virtual-data-center database 804 comprise the physical components of the management component of the virtual data center. The VI-management-server 802 includes a hardware layer 806 and virtualization layer 808 and runs a virtual-data-center management-server virtual machine 810 above the virtualization layer. Although shown as a single server in FIG. 8, the VI-management-server (“VI management server”) may include two or more physical server computers that support multiple VI-management-server virtual appliances. The virtual machine 810 includes a management-interface component 812, distributed services 814, core services 816, and a host-management interface 818. The management interface is accessed from any of various computers, such as the PC 708 shown in FIG. 7. The management interface allows the virtual-data-center administrator to configure a virtual data center, provision virtual machines, collect statistics and view log files for the virtual data center, and to carry out other, similar management tasks. The host-management interface 818 interfaces to virtual-data-center agents 824, 825, and 826 that execute as virtual machines within each of the physical servers of the physical data center that is abstracted to a virtual data center by the VI management server.

The distributed services 814 include a distributed-resource scheduler that assigns virtual machines to execute within particular physical servers and that migrates virtual machines in order to most effectively make use of computational bandwidths, data-storage capacities, and network capacities of the physical data center. The distributed services further include a high-availability service that replicates and migrates virtual machines in order to ensure that virtual machines continue to execute despite problems and failures experienced by physical hardware components. The distributed services also include a live-virtual-machine migration service that temporarily halts execution of a virtual machine, encapsulates the virtual machine in an OVF package, transmits the OVF package to a different physical server, and restarts the virtual machine on the different physical server from a virtual-machine state recorded when execution of the virtual machine was halted. The distributed services also include a distributed backup service that provides centralized virtual-machine backup and restore.

The core services provided by the VI management server include host configuration, virtual-machine configuration, virtual-machine provisioning, generation of virtual-data-center alarms and events, ongoing event logging and statistics collection, a task scheduler, and a resource-management module. Each physical server 820-822 also includes a host-agent virtual machine 828-830 through which the virtualization layer can be accessed via a virtual-infrastructure application programming interface (“API”). This interface allows a remote administrator or user to manage an individual server through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server. The virtual-data-center agents relay and enforce resource allocations made by the VI management server, relay virtual-machine provisioning and configuration-change commands to host agents, monitor and collect performance statistics, alarms, and events communicated to the virtual-data-center agents by the local host agents through the interface API, and to carry out other, similar virtual-data-management tasks.

The virtual-data-center abstraction provides a convenient and efficient level of abstraction for exposing the computational resources of a cloud-computing facility to cloud-computing-infrastructure users. A cloud-director management server exposes virtual resources of a cloud-computing facility to cloud-computing-infrastructure users. In addition, the cloud director introduces a multi-tenancy layer of abstraction, which partitions virtual data centers (“VDCs”) into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

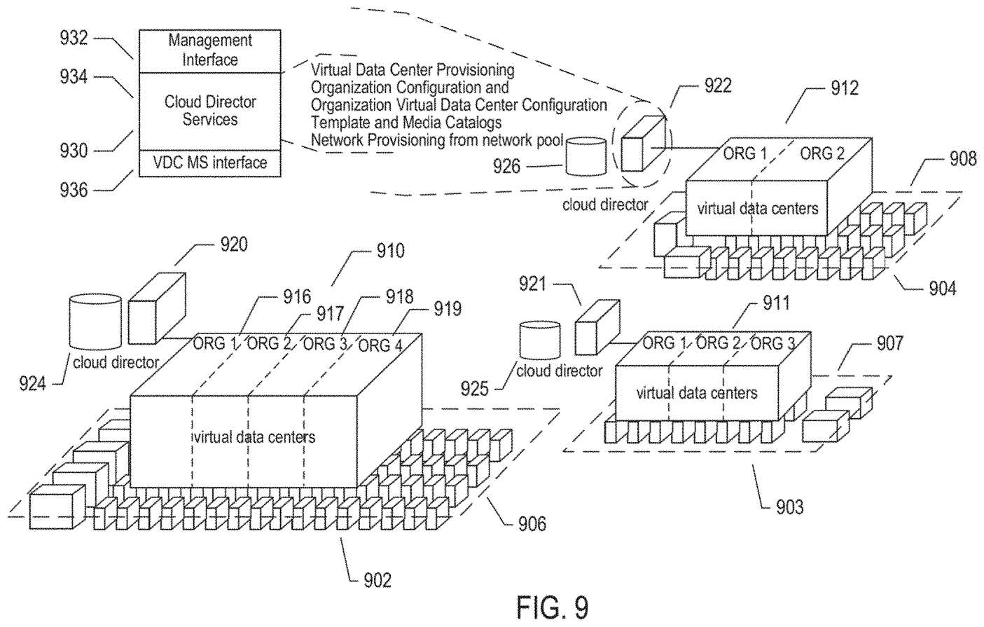

FIG. 9 illustrates a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The resources of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director servers 920-922 and associated cloud-director databases 924-926. Each cloud-director server or servers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are virtual machines that each contains an OS and/or one or more virtual machines containing applications. A template may include much of the detailed contents of virtual machines and virtual appliances that are encoded within OVF packages, so that the task of configuring a virtual machine or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VI management server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

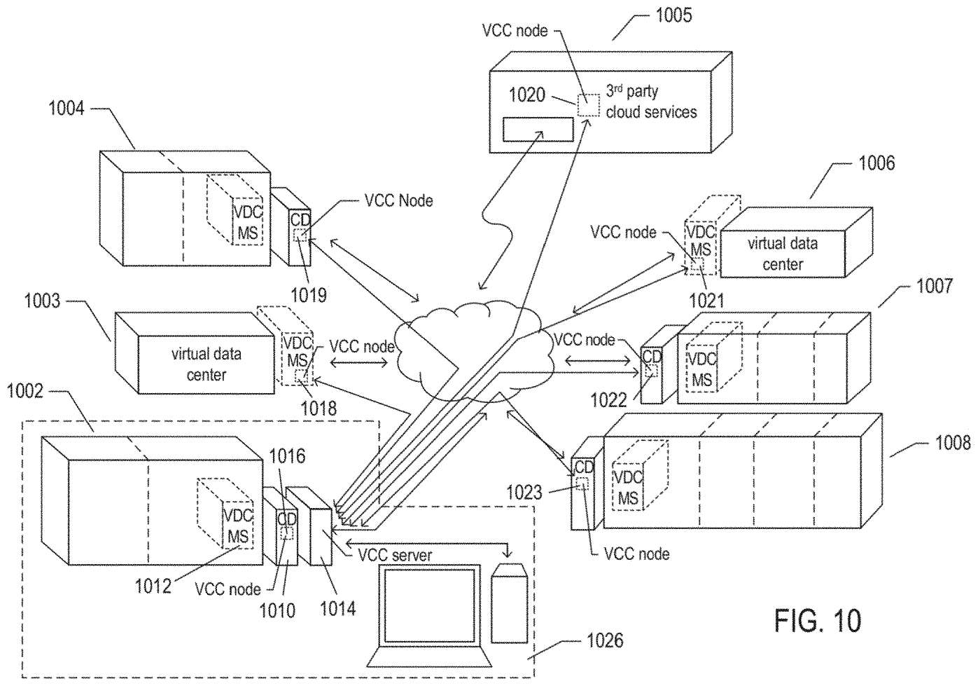

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are illustrated 1002-1008. Cloud-computing facility 1002 is a private multi-tenant cloud with a cloud director 1010 that interfaces to a VI management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VI management server that manages a single-tenant private cloud. The VCC server 1014 additionally interfaces, through the Internet, to VCC node virtual appliances executing within remote VI management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

### Currently Disclosed Methods and Systems

The current document discusses migration of a virtual-network subsystem within a virtual distributed computer system from a first version and/or implementation to a second version and/or implementation as an example of migration of a virtual subsystem within a distributed computer system to which implementations of the currently disclosed methods and systems can be applied. However, the currently disclosed methods and systems can be generally applied to the migration of various different types of virtual subsystems, in addition to virtual-network subsystems.

FIG. 11 illustrates the Open Systems Interconnection model (“OSI model”) that characterizes many modern approaches to implementation of communications systems that interconnect computers. In FIG. 11, two processor-controlled network devices, or computer systems, are represented by dashed rectangles 1102 and 1104. Within each processor-controlled network device, a set of communications layers are shown, with the communications layers both labeled and numbered. For example, the first communications level 1106 in network device 1102 represents the physical layer which is alternatively designated as layer 1. The communications messages that are passed from one network device to another at each layer are represented by divided rectangles in the central portion of FIG. 11, such as divided rectangle 1108. The largest rectangular division 1110 in each divided rectangle represents the data contents of the message. Smaller rectangles, such as rectangle 1111, represent message headers that are prepended to a message by the communications subsystem in order to facilitate routing of the message and interpretation of the data contained in the message, often within the context of an interchange of multiple messages between the network devices. Smaller rectangle 1112 represents a footer appended to a message to facilitate data-link-layer frame exchange. As can be seen by the progression of messages down the stack of corresponding communications-system layers, each communications layer in the OSI model generally adds a header or a header and footer specific to the communications layer to the message that is exchanged between the network devices.

It should be noted that while the OSI model is a useful conceptual description of the modern approach to electronic communications, particular communications-systems implementations may depart significantly from the seven-layer OSI model. However, in general, the majority of communications systems include at least subsets of the functionality described by the OSI model, even when that functionality is alternatively organized and layered.

The physical layer, or layer 1, represents the physical transmission medium and communications hardware. At this layer, signals 1114 are passed between the hardware communications systems of the two network devices 1102 and 1104. The signals may be electrical signals, optical signals, or any other type of physically detectable and transmittable signal. The physical layer defines how the signals are interpreted to generate a sequence of bits 1116 from the signals. The second data-link layer 1118 is concerned with data transfer between two nodes, such as the two network devices 1102 and 1104. At this layer, the unit of information exchange is referred to as a “data frame” 1120. The data-link layer is concerned with access to the communications medium, synchronization of data-frame transmission, and checking for and controlling transmission errors. The third network layer 1120 of the OSI model is concerned with transmission of variable-length data sequences between nodes of a network. This layer is concerned with networking addressing, certain types of routing of messages within a network, and disassembly of a large amount of data into separate frames that are reassembled on the receiving side. The fourth transport layer 1122 of the OSI model is concerned with the transfer of variable-length data sequences from a source node to a destination node through one or more networks while maintaining various specified thresholds of service quality. This may include retransmission of packets that fail to reach their destination, acknowledgement messages and guaranteed delivery, error detection and correction, and many other types of reliability. The transport layer also provides for node-to-node connections to support multi-packet and multi-message conversations, which include notions of message sequencing. Thus, layer 4 can be considered to be a connections-oriented layer. The fifth session layer of the OSI model 1124 involves establishment, management, and termination of connections between application programs running within network devices. The sixth presentation layer 1126 is concerned with communications context between application-layer entities, translation and mapping of data between application-layer entities, data-representation independence, and other such higher-level communications services. The final seventh application layer 1128 represents direct interaction of the communications systems with application programs. This layer involves authentication, synchronization, determination of resource availability, and many other services that allow particular applications to communicate with one another on different network devices. The seventh layer can thus be considered to be an application-oriented layer.

In the widely used TCP/IP communications protocol stack, the seven OSI layers are generally viewed as being compressed into a data-frame layer, which includes OSI layers 1 and 2, a transport layer, corresponding to OSI layer 4, and an application layer, corresponding to OSI layers 5-7. These layers are commonly referred to as “layer 2,” “layer 4,” and “layer 7,” to be consistent with the OSI terminology.

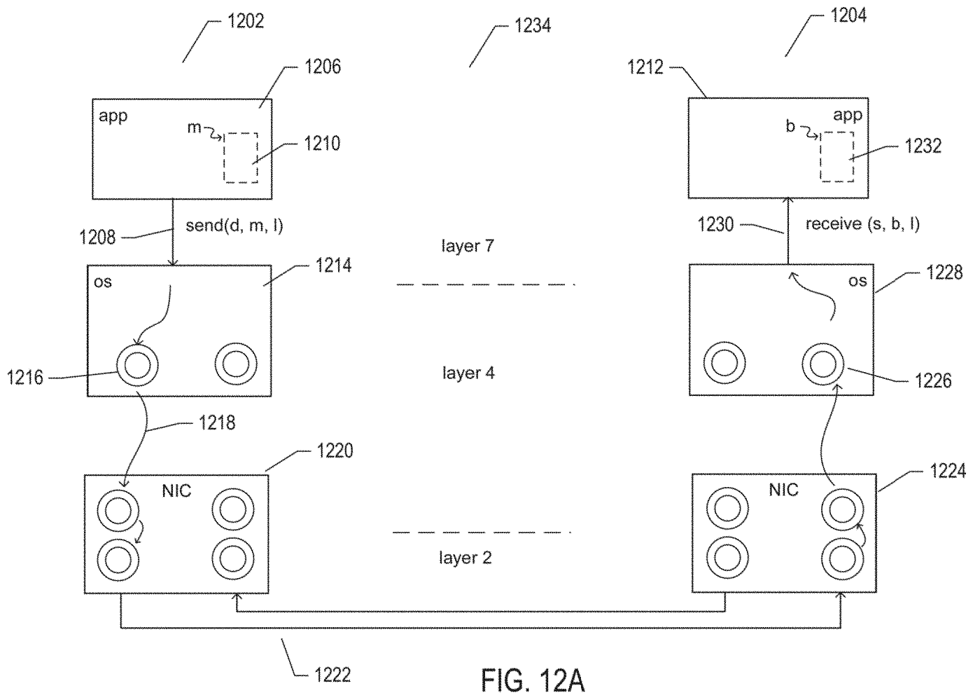

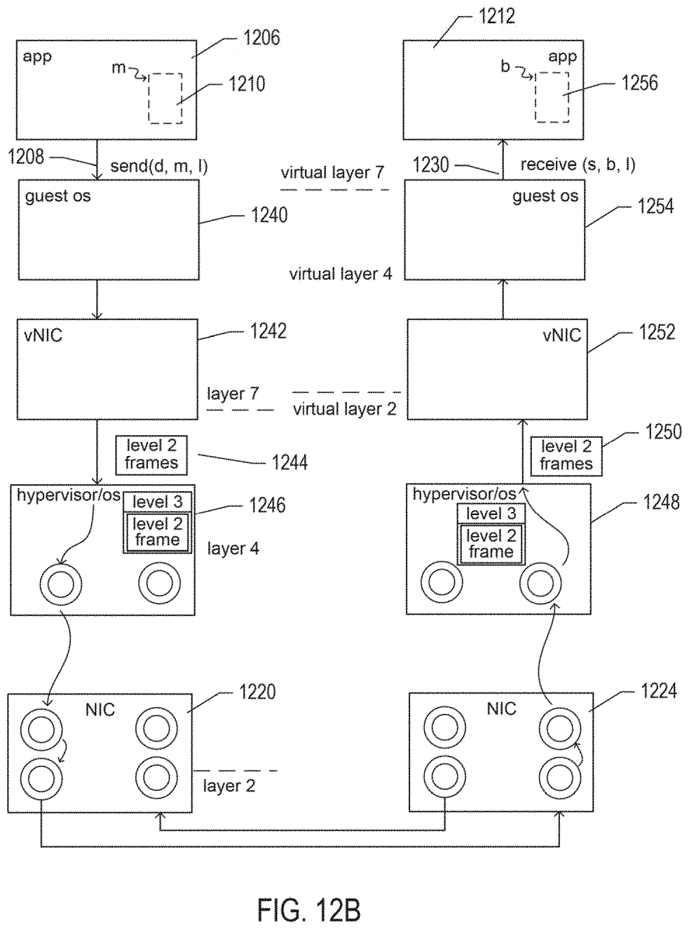

FIGS. 12A-B illustrate a layer-2-over-layer-3 encapsulation technology on which virtualized networking can be based. FIG. 12A shows a traditional network communications between two applications running on two different computer systems. Representations of components of the first computer system are shown in a first column 1202 and representations of components of the second computer system are shown in a second column 1204. An application 1206 running on the first computer system calls an operating-system function, represented by arrow 1208, to send a message 1210 stored in application-accessible memory to an application 1212 running on the second computer system. The operating system on the first computer system 1214 moves the message to an output-message queue 1216 from which it is transferred 1218 to a network-interface-card (“NIC”) 1220, which decomposes the message into frames that are transmitted over a physical communications medium 1222 to a NIC 1224 in the second computer system. The received frames are then placed into an incoming-message queue 1226 managed by the operating system 1228 on the second computer system, which then transfers 1230 the message to an application-accessible memory 1232 for reception by the second application 1212 running on the second computer system. In general, communications are bidirectional, so that the second application can similarly transmit messages to the first application. In addition, the networking protocols generally return acknowledgment messages in response to reception of messages. As indicated in the central portion of FIG. 12A 1234, the NIC-to-NIC transmission of data frames over the physical communications medium corresponds to layer-2 (“L2”) network operations and functionality, layer-4 (“L4”) network operations and functionality are carried out by a combination of operating-system and NIC functionalities, and the system-call-based initiation of a message transmission by the application program and operating system represents layer-7 (“L7”) network operations and functionalities. The actual precise boundary locations between the layers may vary depending on particular implementations.

FIG. 12B shows use of a layer-2-over-layer-3 encapsulation technology in a virtualized network communications scheme. FIG. 12B uses similar illustration conventions as used in FIG. 12A. The first application 1206 again employs an operating-system call 1208 to send a message 1210 stored in local memory accessible to the first application. However, the system call, in this case, is received by a guest operating system 1240 running within a virtual machine. The guest operating system queues the message for transmission to a virtual NIC 1242 (“vNIC”), which transmits L2 data frames 1244 to a virtual communications medium. What this means, in the described implementation, is that the L2 data frames are received by a hypervisor 1246, which packages the L2 data frames into L3 data packets and then either directly, or via an operating system, provides the L3 data packets to a physical NIC 1220 for transmission to a receiving physical NIC 1224 via a physical communications medium. In other words, the L2 data frames produced by the virtual NIC are encapsulated in higher-level-protocol packets or messages that are then transmitted through a normal communications protocol stack and associated devices and components. The receiving physical NIC reconstructs the L3 data packets and provides them to a hypervisor and/or operating system 1248 on the receiving computer system, which unpackages the L2 data frames 1250 and provides the L2 data frames to a vNIC 1252. The vNIC, in turn, reconstructs a message or messages from the L2 data frames and provides a message to a guest operating system 1254, which reconstructs the original application-layer message 1256 in application-accessible memory. Of course, the same process can be used by the application 1212 on the second computer system to send messages to the application 1206 and the first computer system.

The layer-2-over-layer-3 encapsulation technology provides a basis for generating complex virtual networks and associated virtual-network elements, such as firewalls, routers, edge routers, and other virtual-network elements within a virtual data centers, discussed above, with reference to FIGS. 7-10, in the context of a preceding discussion of virtualization technologies that references FIGS. 4-6. Virtual machines and vNICs are implemented by a virtualization layer, and the layer-2-over-layer-3 encapsulation technology allows the L2 data frames generated by a vNIC implemented by the virtualization layer to be physically transmitted, over physical communications facilities, in higher-level protocol messages or, in some cases, over internal buses within a server, providing a relatively simple interface between virtualized networks and physical communications networks.

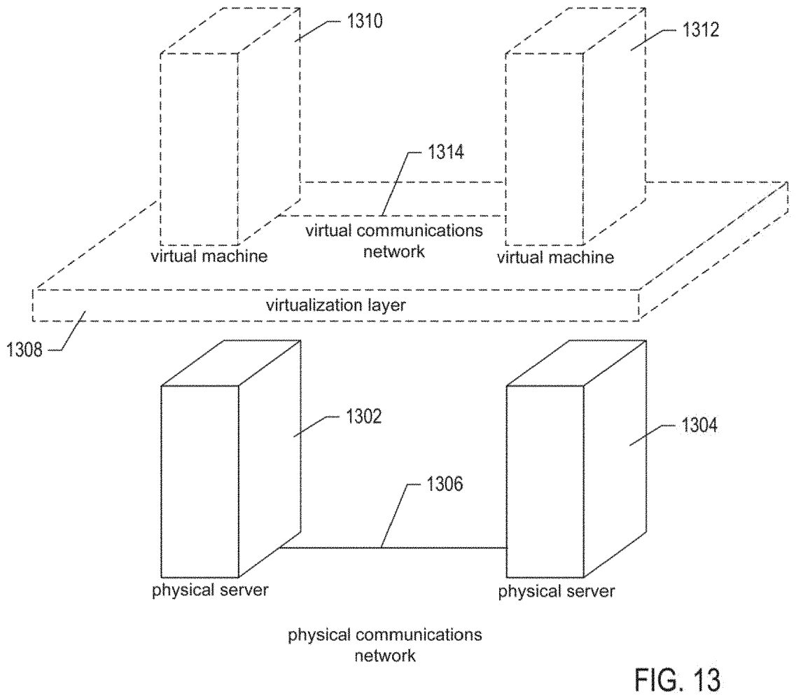

FIG. 13 illustrates virtualization of two communicating servers. A first physical server 1302 and a second physical server 1304 are interconnected by physical communications network 1306 in the lower portion of FIG. 13. Virtualization layers running on both physical servers together compose a distributed virtualization layer 1308, which can then implement a first virtual machine (“VM”) 1310 and a second VM 1312 that are interconnected by a virtual communications network 1314. The first VM and the second VM may both execute on the first physical server, may both execute on the second physical server, or one VM may execute on one of the two physical servers and the other VM may execute on another of the two physical servers. The VMs may move from one physical server to another while executing applications and guest operating systems. The characteristics of the VMs, including computational bandwidths, memory capacities, instruction sets, and other characteristics, may differ from the characteristics of the underlying servers. Similarly, the characteristics of the virtual communications network 1314 may differ from the characteristics of the physical communications network 1306. As one example, the virtual communications network 1314 may provide for interconnection of 10, 20, or more virtual machines, and may include multiple local virtual networks bridged by virtual switches or virtual routers, while the physical communications network 1306 may be a local area network (“LAN”) or point-to-point data exchange medium that connects only the two physical servers to one another. In essence, the virtualization layer 1308 can construct any number of different virtual machines and virtual communications networks based on the underlying physical servers and physical communications network. Of course, the virtual machines' operational capabilities, such as computational bandwidths, are constrained by the aggregate operational capabilities of the two physical servers and the virtual networks' operational capabilities are constrained by the aggregate operational capabilities of the underlying physical communications network, but the virtualization layer can partition the operational capabilities in many different ways among many different virtual entities, including virtual machines and virtual networks.

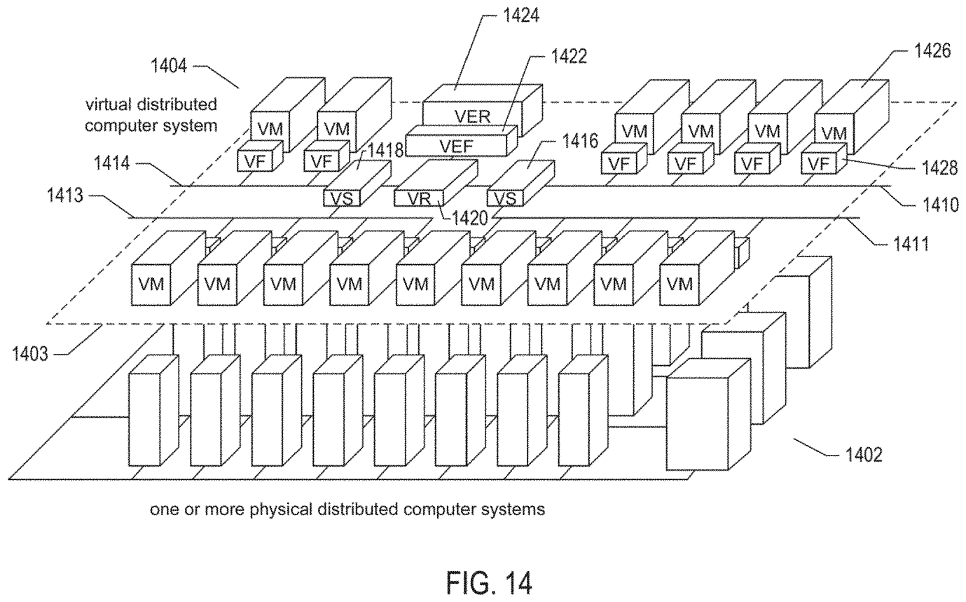

FIG. 14 illustrates a virtual distributed computer system based on one or more distributed computer systems. The one or more physical distributed computer systems 1402 underlying the virtual/physical boundary 1403 are abstracted, by virtualization layers running within the physical servers, as a virtual distributed computer system 1404 shown above the virtual/physical boundary. In the virtual distributed computer system 1404, there are numerous virtual local area networks (“LANs”) 1410-1414 interconnected by virtual switches (“vSs”) 1416 and 1418 to one another and to a virtual router (“vR”)1421. The vR interconnects the virtual router through a virtual edge-router firewall (“vEF”)1422 to a virtual edge router (“vER”)1424 that, in turn, interconnects the virtual distributed computer system with external data centers, external computers, and other external network-communications-enable devices and systems. A large number of virtual machines, such as virtual machine 1426, are connected to the LANs through virtual firewalls (“vFs”), such as vF 1428. The VMs, vFs, vSs, vR, vEF, and vER are implemented largely by execution of stored computer instructions by the hypervisors within the physical servers, and while underlying physical resources of the one or more physical distributed computer systems are employed to implement the virtual distributed computer system. The components, topology, and organization of the virtual distributed computer system are largely independent from the underlying one or more physical distributed computer systems.

Virtualization provides many important and significant advantages. Virtualized distributed computer systems can be configured and launched in time frames ranging from seconds to minutes, while physical distributed computer systems often require weeks or months for construction and configuration. Virtual machines can emulate many different types of physical computer systems with many different types of physical computer-system architectures, so that a virtual distributed computer system can run many different operating systems, as guest operating systems, that would otherwise not be compatible with the physical servers of the underlying one or more physical distributed computer systems. Similarly, virtual networks can provide capabilities that are not available in the underlying physical networks. As one example, the virtualized distributed computer system can provide firewall security to each virtual machine using vFs, as shown in FIG. 14. This allows a much finer granularity of network-communications security, referred to as “microsegmentation,” than can be provided by the underlying physical networks. Additionally, virtual networks allow for partitioning of the physical resources of an underlying physical distributed computer system into multiple virtual distributed computer systems, each owned and managed by different organizations and individuals, that are each provided full security through completely separate internal virtual LANs connected to virtual edge routers. Virtualization thus provides capabilities and facilities that are unavailable in non-virtualized distributed computer systems and that provide enormous improvements in the computational services that can be obtained from a distributed computer system.

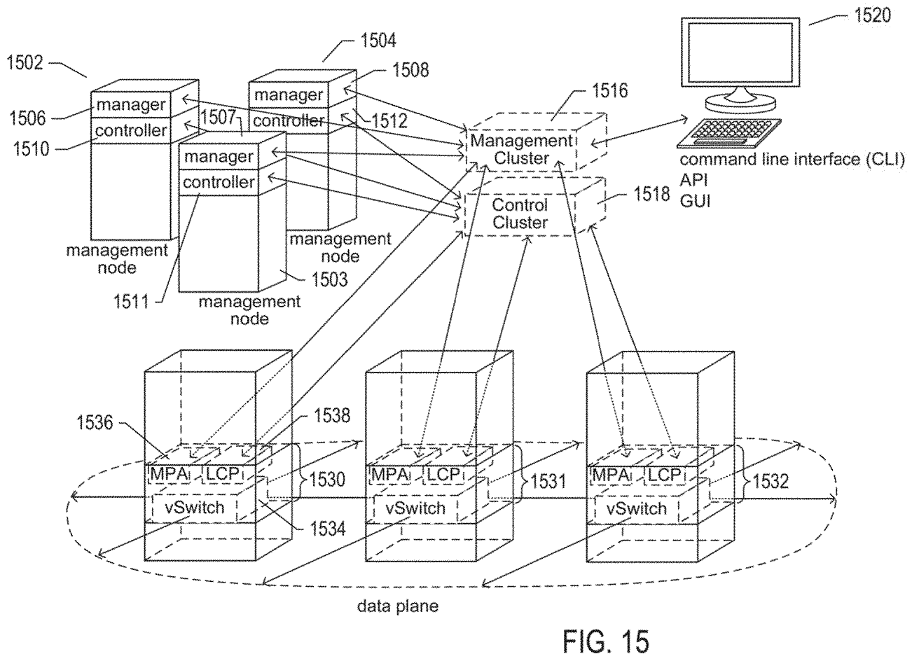

FIG. 15 illustrates components of several implementations of a virtual network within a distributed computing system. The virtual network is managed by a set of three or more management nodes 1502-1504, each including a manager instance 1506-1508 and a controller instance 1510-1512. The manager instances together comprise a management cluster 1516 and the controllers together comprise a control cluster 1518. The management cluster is responsible for configuration and orchestration of the various virtual networking components of the virtual network, discussed above, and provisioning of a variety of different networking, edge, and security services. The management cluster additionally provides administration and management interfaces 1520, including a command-line interface (“CLI”), an application programming interface (“API”), and a graphical-user interface (“GUI”), through which administrators and managers can configure and manage the virtual network. The control cluster is responsible for propagating configuration data to virtual-network components implemented by hypervisor's within physical servers and facilitates various types of virtual-network services. The virtual-network components implemented by the hypervisors within physical servers 1530-1532 provide for communications of messages and other data between virtual machines, and are collectively referred to as the “data plane.” Each hypervisor generally includes a virtual switch, such as virtual switch 1534, a management-plane agent, such as management-plane agent 1536, and a local-control-plane instance, such as local-control-plane instance 1538, and other virtual-network components. A virtual network within the virtual distributed computing system is, therefore, a large and complex subsystem with many components and associated data-specified configurations and states.

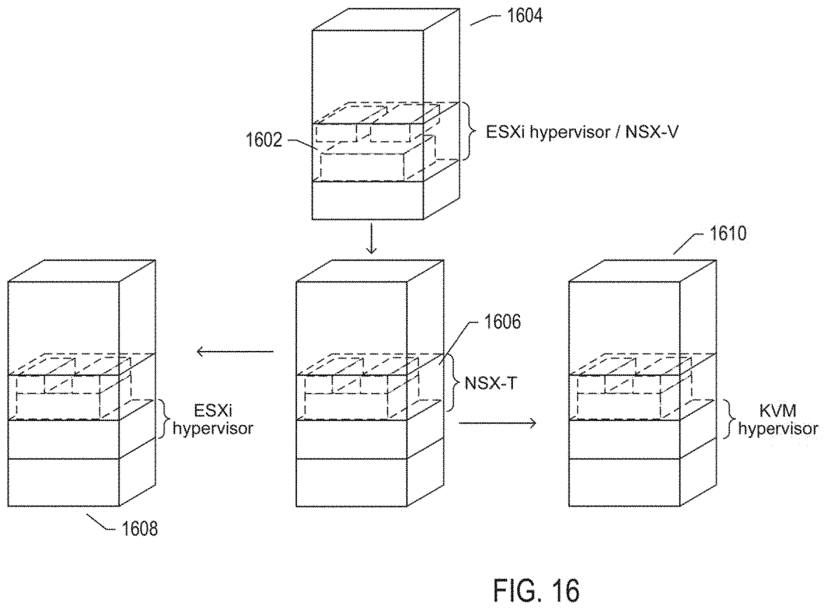

FIG. 16 illustrates two different versions and/or implementations of one type of virtual network. FIG. 16 uses the same illustration conventions for servers as used in FIG. 15. A VMware ESXi hypervisor 1602 that incorporates a first version of the NSX virtual-network subsystem, referred to as “NSX-V,” is shown in a first server 1604 at the top of FIG. 16. A second version of the NSX virtual-network subsystem, referred to as “NSX-T,” was subsequently developed as an independent virtual-network subsystem 1606 that can interface to either the VMware ESXi hypervisor, as shown in server 1608, or to the Linux KVM hypervisor, as shown in server 1610. The NSX-V virtual-network subsystem differs from the NSX-T virtual-network subsystem in many ways. For example, the NSX-T virtual-network subsystem employs a more modern Geneve overlay technology and various additional improved functionalities and capabilities with respect to the older NSX-V in addition to the ability to layer NSX-T over different types of hypervisors. The NSX-V virtual-network subsystem has a very different architecture than the architecture of the NSX-T virtual-network subsystem, and the two virtual-network subsystems employ very different data schemas and data-object definitions. NSX-T extends NSX-V coverage of on-premises computational entities to include multi-hypervisors, containers, public clouds, and bare metal servers. Since NST-X is decoupled from a proprietary hypervisor platform, NST-X can easily incorporate agents, which can be used to provide micro-segmentation on non-proprietary platforms. NSX-T is standalone solution compared to NSX-V, which is tightly coupled to proprietary virtualization system.

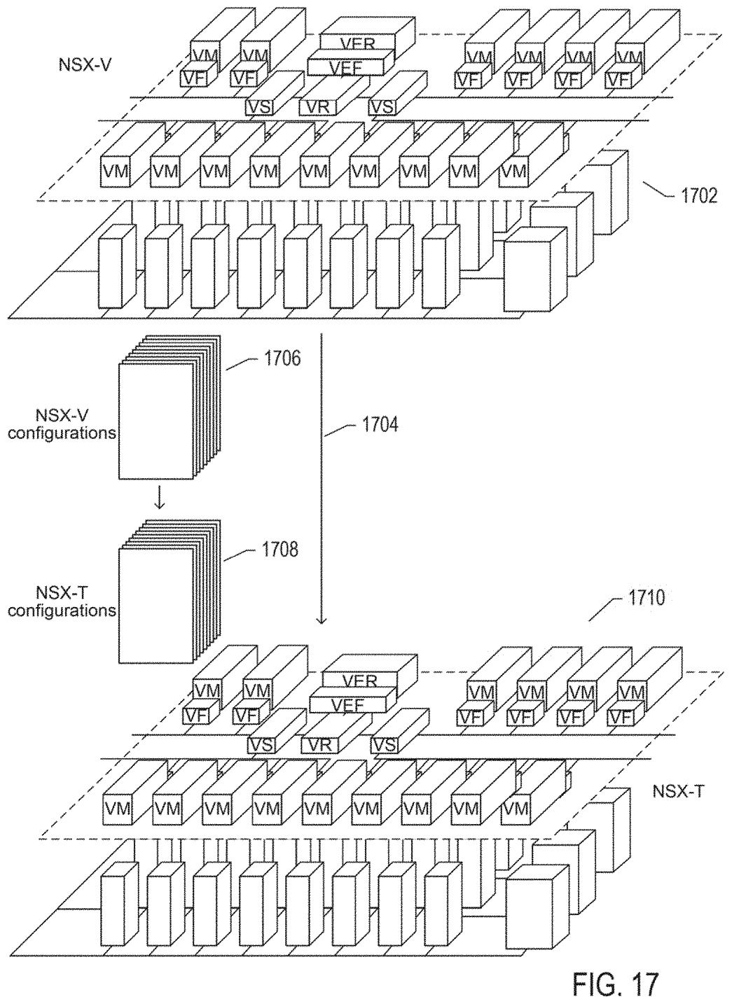

FIG. 17 illustrates in-place migration of a virtual-network subsystem within a virtual distributed computer system from NSX-V to NSX-T. The virtual distributed computer system, initially using an NSX-V virtual-network subsystem 1702, is shown at the top of FIG. 17. As discussed above, the virtual distributed computer system is a very complex system with many different components and a generally complex virtual-network topology according to which a large number of virtual-network components, including virtual firewalls, virtual switches, virtual routers, and virtual LANs, all of which contain and use large amounts of stored configuration and state data, are organized. The term “virtual” can be somewhat misleading to those unfamiliar with modern computer science, particularly since this term is often used in juxtaposition with the term “physical.” However, a virtual subsystem, such as a virtual-network subsystem, is every bit as physical as the underlying hardware components of one or more physical distributed computer systems that implement the virtual subsystem. The term “virtual” does not mean “abstract,” “imaginary,” or “non-existent,” but instead indicates that the system or subsystem qualified by the adjective “virtual” is implemented both by the components of an underlying physical computer system as well as by additional computer-instruction-implemented components. Indeed, all computer systems, whether or not characterized as being “virtual,” include many components and subsystems implemented by a combination of hardware components and computer-instruction-implemented components. Most modern computer systems, for example, use processors with microcoded instructions. The processor instructions stored in executable files refer to an essentially virtual instruction set that is implemented within the processor by what are essentially routines comprising sets of lower-level microinstructions. A virtual-network subsystem, such as NSX-V and NSX-T, is physically instantiated and provides real-world functionality and capabilities. Those familiar with science and technology also understand that stored instructions that are executed by a processor are every bit as physical as the processor that executes them. There is no physical/non-physical boundary in a computer system. A computer system is simply a machine.

Many virtual distributed computer systems provide services to large numbers of remote clients who require the services to be continuously available, without interruption. Even those clients that do not require continuous availability may often require that the services be provided with fixed maximum latencies and other performance specifications. Thus, owners and managers of many virtual distributed computer systems generally cannot tolerate extended periods of downtime, and can often not tolerate even brief service interruptions. When a new version and/or implementation of a fundamental system component of a virtual distributed computer system becomes available, there are often many compelling reasons to update the virtual distributed computer system to incorporate the new version and/or implementation. As an example, updating, or migration, from NSX-V to NSX-T can provide many performance improvements and significant expansion of capabilities of the virtual distributed computer system, including multi hypervisor support, multi-cloud support, increased scalability, and increased performance. NSX-T extends NSX-V coverage of on-premises computational entities to include multi-hypervisors, containers, public clouds, and bare metal servers. Since NST-X is decoupled from a proprietary hypervisor platform, NST-X can easily incorporate agents, which can be used to provide micro-segmentation on non-proprietary platforms. NSX-T is standalone solution compared to NSX-V, which is tightly coupled to proprietary virtualization system. In certain cases, a migration eventually becomes essential, as support for an older version and/or implementation becomes unavailable, and the older implementation and/or version therefore becomes essentially unusable. For these reasons, it is often necessary to carry out much of a migration from an older version and/or implementation to a newer version and/or implementation of a particular virtual subsystem while the older version and/or implementation continues to operate. This involves deploying the new implementation and/or version in parallel with the older version and/or implementation, configuring the new implementation and/or version while the older version and/or implementation continues to operate, and then, once the new implementation and/or version is fully operational, quickly transitioning to use of the new implementation and/or version and deinstallation of the older implementation and/or version. This type of migration can often avoid service interruption and down time and, even when such interruptions cannot be completely avoided, can prevent lengthy interruptions, particularly when the virtual distributed computer system is heavily loaded with critical computational tasks. Thus, as illustrated in FIG. 17, migration of the virtual distributed computer system 1702 from NSX-V to NSX-T, as represented by arrow 1704, generally involves collecting a complete description 1706 of the configuration and state of the NSX-V system, using the collected description to generate a corresponding NSX-T configuration 1708, and then deploying and configuring NSX-T in the virtual distributed computer system, so that the virtual distributed computer system can be quickly transitioned, towards the end of the process, to use the deployed and configured NSX-T, resulting in the same virtual distributed computer system 1710 with the exception that NSX-T, rather than NSX-V, is used as the virtual-network subsystem.

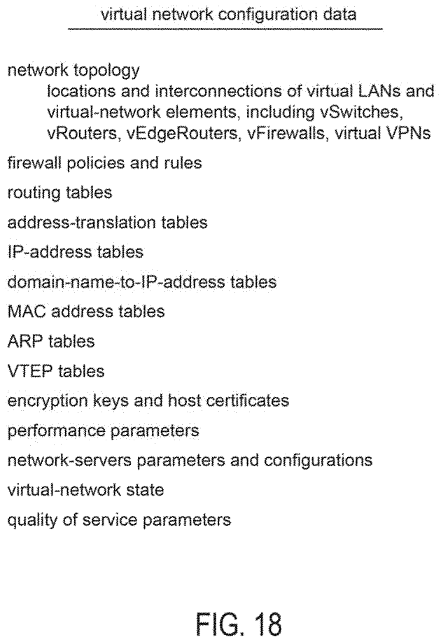

FIG. 18 lists examples of the many types of virtual-network configuration data that describe the configuration and state of a virtual-network subsystem. This data includes a full description of the virtual-network topology, including the locations and interconnections of virtual local-area networks (“vLANs”) and the locations and connections between various types of virtual-network elements, including virtual switches, routers, edge routers, firewalls, virtual private networks (“vVPNs). This data also includes firewall policies and rules for all of the various virtual firewalls, routing tables, address-translation tables, IP-address tables, domain-name-to-IP-address tables, media-access-control (“MAC”) address tables, address-resolution-protocol (“ARP”) tables, virtual tunnel endpoint (“VTEP”) tables, encryption keys and host certificates associated with security features and policies, performance parameters, network-services parameters and configurations, quality-of-service parameters, various state information, and many other type of data. In addition, as mentioned above, the configuration data retrieved from an NSX-V installation needs to be translated into corresponding configuration data for input to an NSX-T installation. The configuration data is retrieved through one or more of the API and CLI administration-and-management interfaces provided by the management plane as well as similar interfaces provided by local ESXi-hypervisor installations, and has a particular format, vocabulary, and syntax. However, certain of the configuration data input to an NSX-T installation requires a different format, vocabulary, and syntax. Thus, a variety of techniques and technologies need to be employed to translate configuration data retrieved from an NSX-V installation to corresponding NSX-T configuration data for input to configure a newly deployed NSX-T system. In addition, because of differences in the implementations of NSX-V and NSX-T, certain configuration data applicable to an NSX-V virtual network may not be applicable to an NSX-T virtual network and vice versa. Because of the large volume of configuration data, the complexity of a virtual-network subsystem, and the many different types of operations needed to transform the NSX-V configuration data to NSX-T configuration data, a migration is often associated with problems and deficiencies, including various subtle secondary problems that are difficult to anticipate and detect.

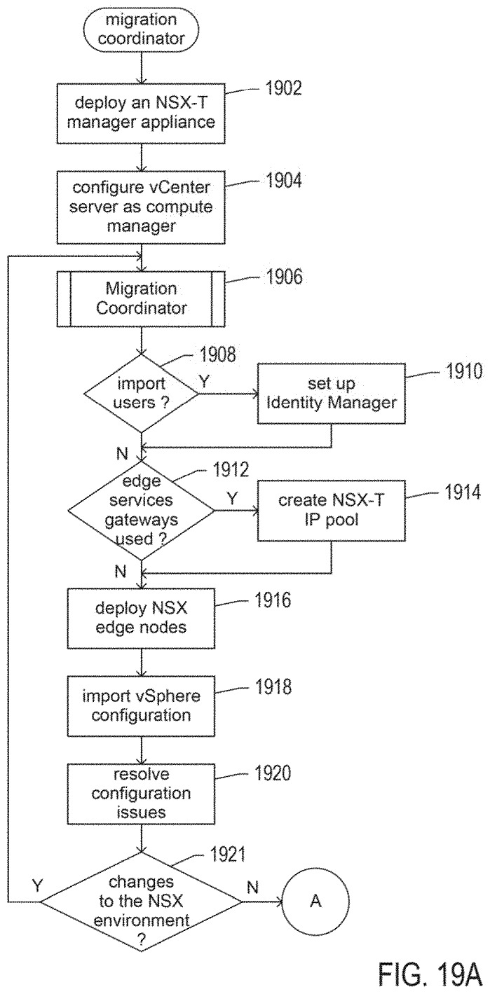

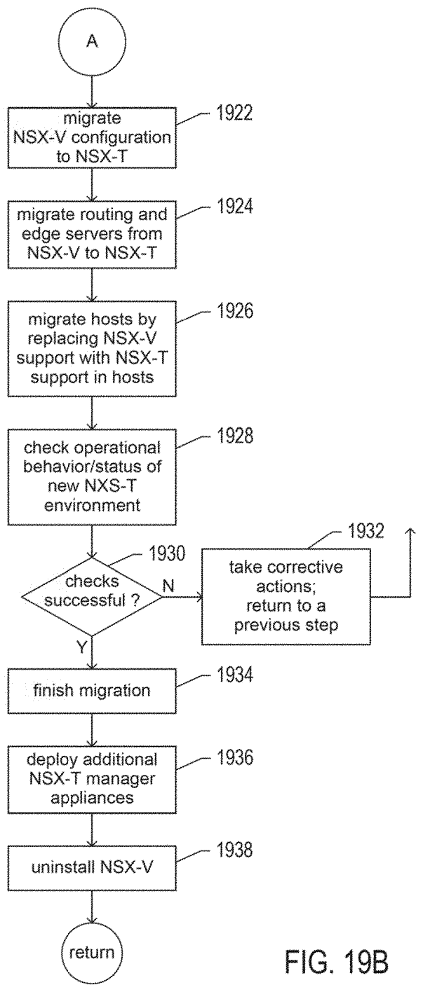

FIGS. 19A-B provide control-flow diagrams that illustrate an NSX-V-to-NSX-T-migration process using a migration coordinator that facilitates migration of a virtual-network subsystem within a virtual distributed computer system from NSX-V to NSX-T. The migration coordinator is launched to control and facilitate migration of a virtual subsystem within a virtual distributed computer system from a first implementation and/or version to a second implementation and/or version. The migration coordinator described in the control-flow diagrams of FIGS. 19A-B is specifically implemented to facilitate and control migration of a virtual-network subsystem from NSX-V to NSX-T. In this implementation, the migration coordinator interacts through a GUI with an administrator or manager of the virtual distributed computer system. In step 1902, the GUI directs an administrator or manager user to deploy an NSX-T manager appliance, a virtual appliance that implements the manager within a management node, discussed above with reference to FIG. 15, within the virtual distributed computer system. In step 1904, the migration coordinator directs the user to configure a vCenter server as a compute manager. In step 1906, the migration coordinator is launched. Many of the subsequent steps, up through step 1934 in FIG. 19B, represent operations carried out by the migration coordinator. When import of users from NSX-V into NSX-T is desired, as determined in step 1908, an identity manager is set up and configured, in step 1910. When the NSX-V implementation and/or version employs edge services gateways, as determined in step 1912, an NSX-T IP pool is created, in step 1914. In step 1916, NSX-T edge nodes are deployed. In step 1918, a vSphere configuration is imported into NSX-T. In step 1920, any detected configuration issues are resolved, which may involve user participation. If the resolution of the configuration issues involve changes to the NSX-V environment, as determined in step 1921, those changes are made and the migration coordinator is then restarted, as represented by the arrow from step 21 back to step 1906. Turning to FIG. 19B, in step 1922, the migration coordinator migrates the NSX-V configuration from the NSX-V virtual-network subsystem, which continues to operate within the virtual distributed computer system, to the nascent NXT-T virtual-network subsystem. In step 1924, the routing and edge service are migrated from the NSX-V virtual-network subsystem to the nascent NXT-T virtual-network subsystem. In step 1926, NSX-V components within each host server underlying the virtual distributed computer system are replaced with corresponding NXT-T components. In step 1928, the operational status of the nascent NXT-T virtual-network subsystem is checked. When the checks carried out in step 1928 fail, as determined in step 1930, various different types of corrective actions are taken, in step 1932, which may involve user participation. After the corrective actions are taken, a portion of the previous steps may be repeated, depending on the types and level of the corrective actions taken. In step 1934, final migration steps are carried out. In step 1936, additional NXS-T management nodes are configured and launched. Finally, in step 1938, the NSX-V virtual-network subsystem is uninstalled.

While it is true that, for example, in step 1928, the migration coordinator does attempt to check that the newly configured and launched NSX-T environment is operational, there are frequently significant problems and deficiencies that are not detected by the migration coordinator and that can, over time, result in significant data loss and virtual-network-system failures. Many of these problems are related to proper migration of NSX-V data to the new NSX virtual-network system. Other problems and deficiencies that cannot be detected by the migration coordinator, such as failures to properly migrate firewalls along with updated firewall policies and rules, may eventually result in security breaches and downstream problems that are notoriously difficult to detect and anticipate and that are difficult to diagnose, when problems eventually occur. Despite the importance and critical nature of proper NSX-V-to- NSX-T migration, and despite the operational checks implemented in the migration coordinator, many users of the migration coordinator are not confident that the migration has fully reproduced an NSX-T virtual-network subsystem equivalent to the previously operating NSX-V virtual-network subsystem at the end of the migration process. A user may carry out many independent checks and verifications steps, using tools and facilities provided by the management cluster of the NSX-T virtual-network subsystem to attempt to increase the users confidence in the newly installed and launched NSX-T virtual-network subsystem, but due to the complexity and size of the migration process, including the complexity and size of the configuration data associated with the replaced NSX-V virtual-network subsystem and the newly installed NSX-T virtual-network subsystem, it is generally not possible for a user to achieve anything close to full confidence that the newly installed NSX-T virtual-network subsystem faithfully and accurately replicates the state and configuration of the previously operating NSX-V virtual-network subsystem. For many owners and managers of virtual distributed computer systems, the inability to achieve full confidence in a newly installed NSX-T virtual-network subsystem provides significant inhibition and reluctance to migrate from a currently installed NSX-V virtual-network subsystem to an NSX-T virtual-network subsystem. However, as discussed above, by failing to migrate to NSX-T, the user is unable to take advantage of significant improvements in the virtual-network subsystems and, as time goes on, the user's virtual distributed computer system falls further and further behind the reliability and performance standards expected of virtual distributed computer systems. Furthermore, the risk of incomplete or unfaithful migration often continues to increase as new versions of NSX-T incorporate additional features and capabilities. The currently disclosed virtual-subsystem-migration validator methods and systems provide a new tool for verifying the correctness of an NSX-V-to-NSX-T migration that is independent from the checks and verifications carried out by the current migration coordinator and that can substantially decrease the likelihood of significant, undetected problems and deficiencies in a newly launched NSX-T virtual-network subsystem following an NSX-V-to-NSX-T migration.

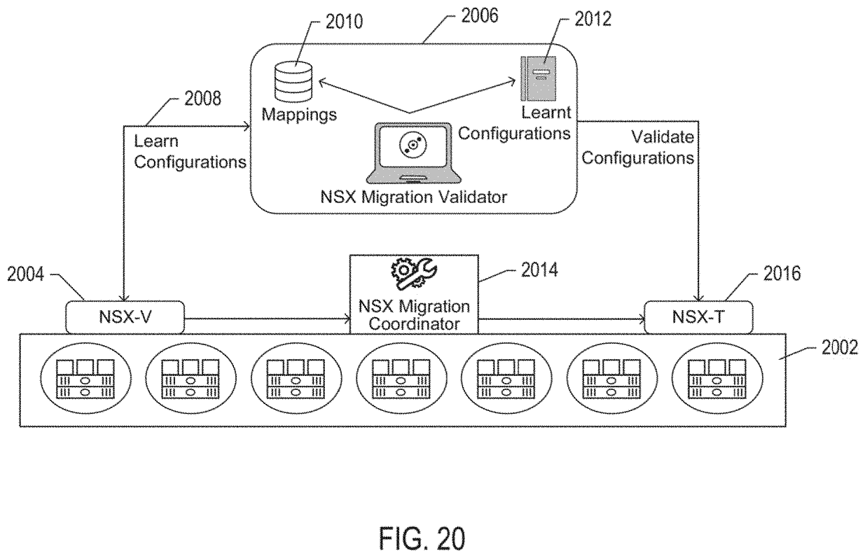

FIG. 20 provides a high-level illustration of the currently disclosed virtual-subsystem-migration validator within an NSX-V to NSX-T migration context. A distributed computer system is represented as layer 2002 in FIG. 20. Initially, the distributed computer system includes an NSX-V virtual-network subsystem 2004. The virtual-subsystem-migration validator 2006 extracts a set of configuration files from the NSX-V virtual-network subsystem 2004, as represented by arrow 2008, and uses mapping information 2010 to generate a corresponding set of intents 2012, discussed further below. The intents provide a natural-language representation of the configurations, specified by the corresponding configuration files, from which specific, equivalent configurations for NSX-T can be generated. A migration coordinator 2014 is then used to attempt to generate an NSX-T virtual-network subsystem 2016 for the distributed computer system equivalent to the NSX-V virtual-network subsystem 2004. While the NSX-T virtual-network subsystem is being generated, the NSX-V virtual-network subsystem continues to operate. Following generation of the NSX-T virtual-network subsystem, the intents 2012 can be compared to intents generated from configuration files extracted from the newly generated NSX-T virtual-network subsystem to validate the equivalence of the newly generated NSX-T virtual-network subsystem and NSX-V virtual-network subsystem. When the newly generated NSX-T virtual-network subsystem is found to be equivalent to the NSX-V virtual-network subsystem, the migration of the distributed computer system from NSX-V to NSX-T is finalized and the NSX-V virtual-network subsystem uninstalled. Otherwise, differences found in the comparison of the intents corresponding to the NSX-V virtual-network subsystem and the NSX-T virtual-network subsystem can be used to a bring the NSX-T into equivalence with the NSX-V virtual-network subsystem or, in other cases, the migration can be restarted following more comprehensive remediation operations. The virtual-subsystem-migration validator may be resident within the distributed computer system or may execute in a remote computer system.

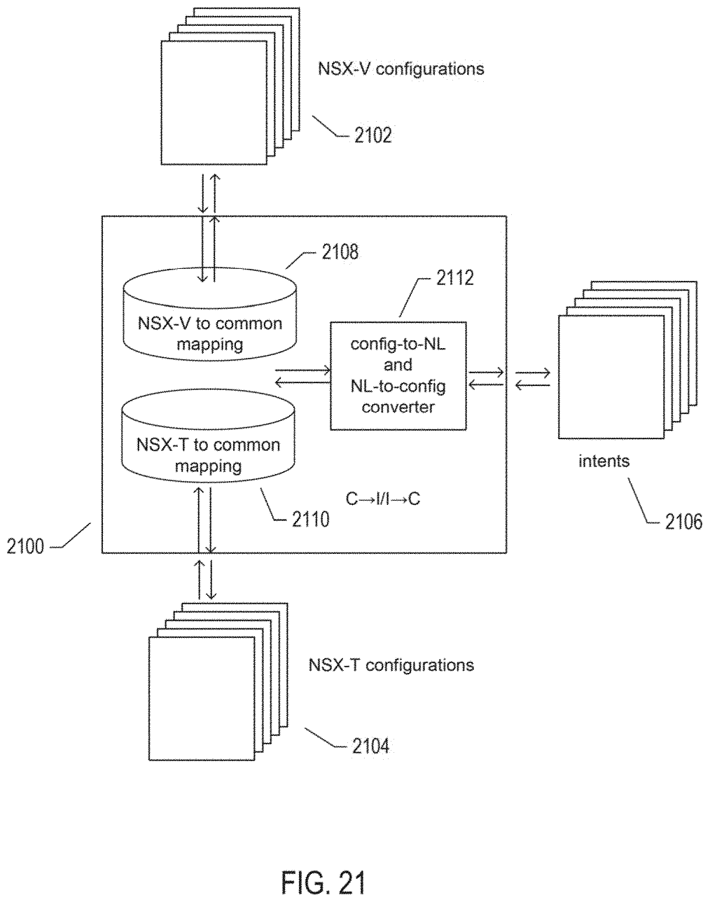

FIG. 21 illustrates one component of one implementation of the currently disclosed virtual-subsystem-migration validator. This component is referred to as the “C→C component” in the following discussion. The “C” symbol in the component name refers to “configuration” and the “I” symbol in the component name refers to “intent.” The C→I/I→C component processes and produces NSX-V configurations 2102, NSX-T configurations 2104, and intents 2106. In one operational mode, the C→I/I→C component receives a set of NSX-V configurations 2102 and produces a corresponding set of intents 2106. In a second operational mode, the C→I/I→C component receives a set of intents 2106 and produces a corresponding set of NSX-V configurations 2102. In a third operational mode, the C→I/I→C component receives a set of intents 2106 and produces a corresponding set of NSX-T configurations 2104. In a fourth operational mode, the C→I/I→C component receives a set of NSX-T configurations 2104 and produces a corresponding set of intents 2106. Configurations are, in many implementations, files that contain formatted configuration data returned in response to configuration-data requests submitted to the management plane of a virtual-network subsystem through the management-plane CLI or API interfaces. In some cases, the configurations are obtained by similar requests made directly to virtual-network-system components within host hypervisors. Intents, by contrast, contain the same information as corresponding configurations, but the information is organized according to an intent format and is translated into a natural-language form that can be readily understood by a human reader. As discussed above, the format, vocabulary, and syntax of an NSX-V configuration file generally differs from the format, vocabulary, and syntax of an NSX-T configuration file. Since both NSX-V configuration files and NSX-T configuration files can be automatically translated into intents, the intents serve as a common representation of configuration information. The C→C component 2100 contains stored NSX-V-to-intent mapping information 2108 and NSX-T-to-intent mapping information 2110 as well as bidirectional translation logic 2112 that can convert intents to either of the two different types of configurations and that can convert either of the two types of configurations to intents. The mapping information can include tables of corresponding terms and phrases as well as translation rules, regular expressions, and translation functions. Of course, the particular translation rules, regular expressions, tables of corresponding terms and phrases, and translation functions are highly implementation-dependent and version-dependent, but, as with natural languages, it is possible to accurately and reliably translate configuration files to intents and intents to configuration files by automated processes.

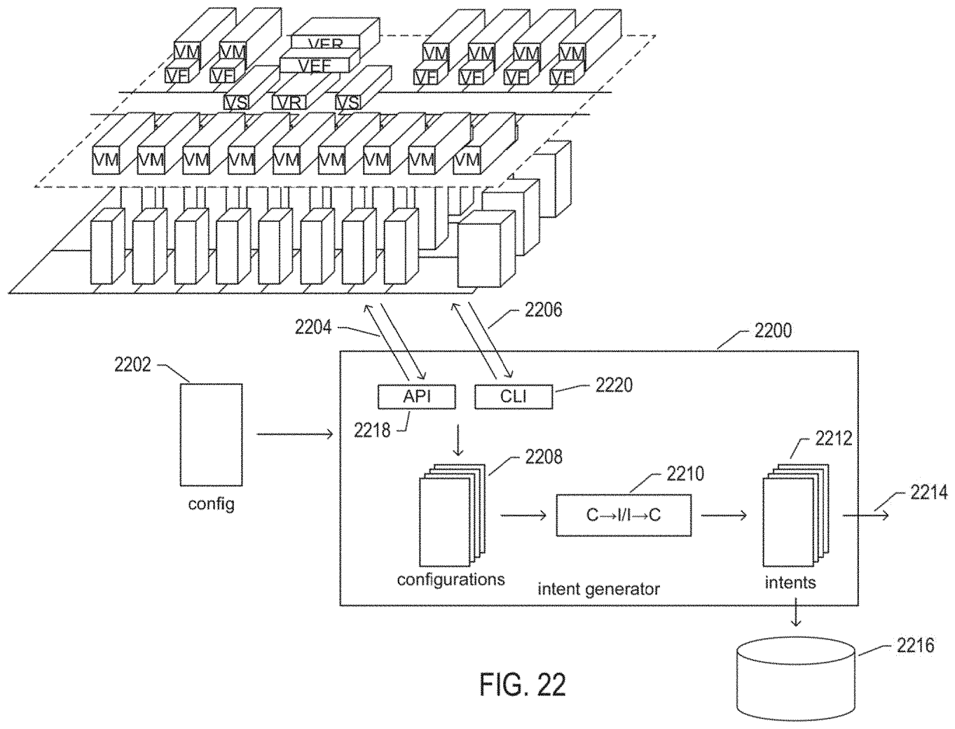

FIG. 22 illustrates a second component of one implementation of the currently disclosed virtual-subsystem-migration validator. This component is referred to as the “intent generator” in the following discussion. The intent generator 2200 receives a config file 2202, which specifies the exact operation to be performed by the intent generator and which includes the needed passwords and authorizations to allow the intent generator to access management-plane tools provided by a virtual-network subsystem. The intent generator accesses these management-plane tools, as represented by the pair of arrows 2204 and the pair of arrows 2206 to retrieve a complete set of configuration files 2208 from the specified virtual-network subsystem. The intent generator then invokes a C→I/I→C component 2210 to translate the configuration files into corresponding intents 2212. These intents may be directly transmitted to a receiving entity, as represented by arrow 2214, or may be persistently stored, as represented by icon 2216, for later access by a receiving entity. As indicated by items 2218 and 2220, the intent generator accesses the management-plane tools of the virtual-network subsystem through one or both of the API and CLI interfaces. In addition, an intent generator can access virtual-network-system components within host systems through CLI interfaces to host supervisors, in certain implementations.

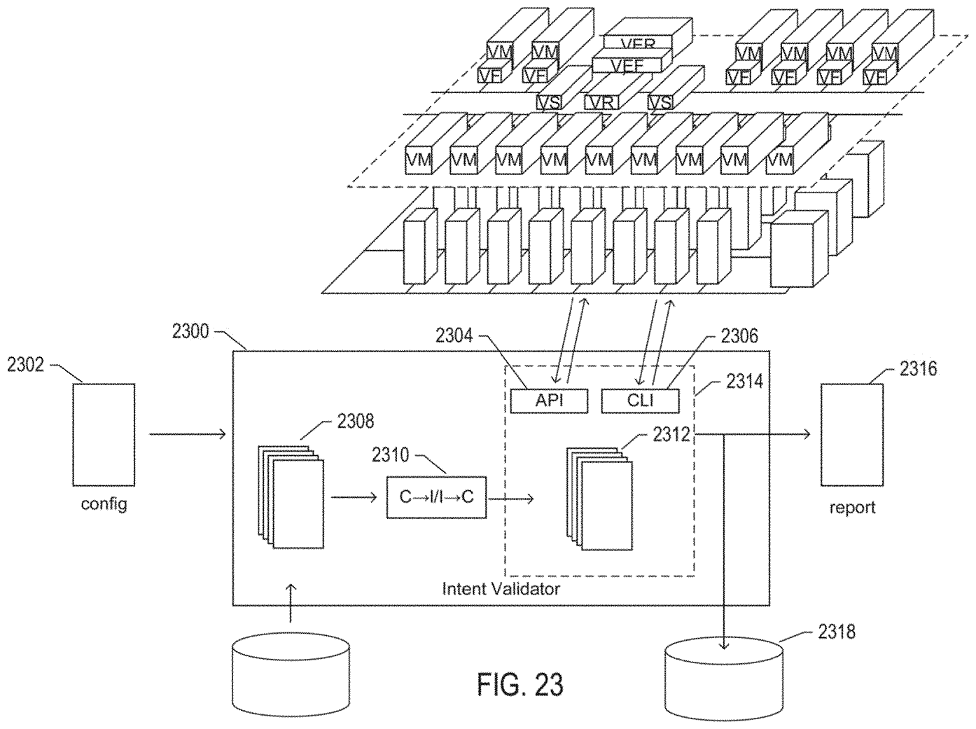

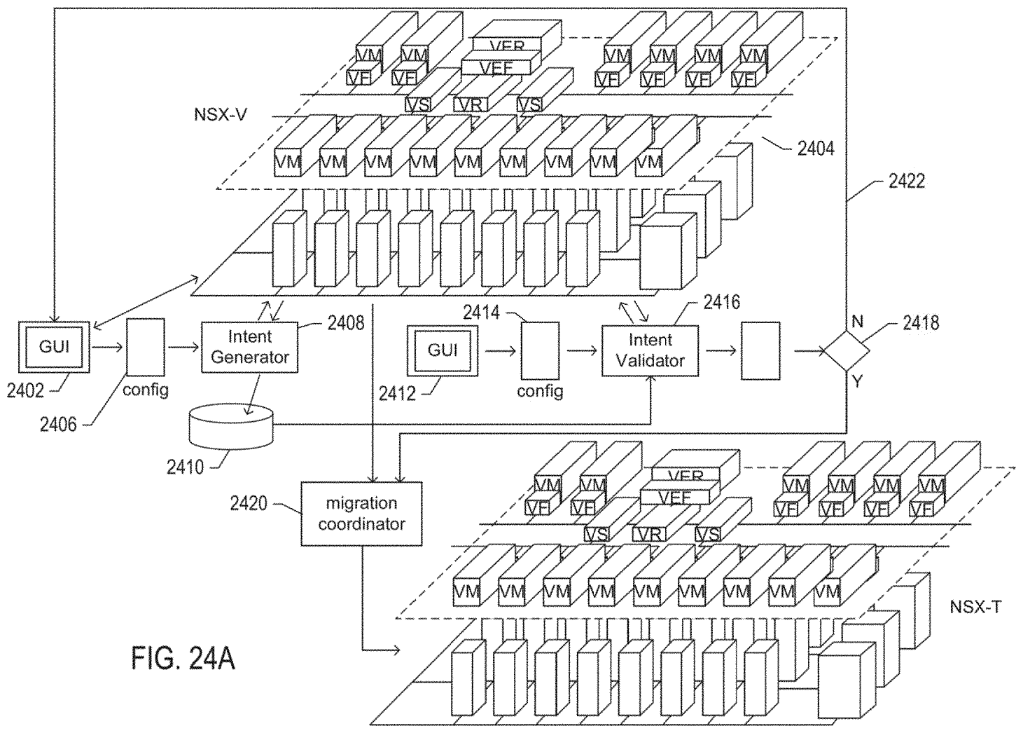

FIG. 23 illustrates a third component of one implementation of the currently disclosed virtual-subsystem-migration validator. This component is referred to as the “intent validator” in the following discussion. Like the previously discussed intent generator, the intent validator 2300 is controlled by a received config file 2302 and accesses management-point tools of a virtual-network subsystem through one or both of an API interface 2304 and a CLI interface 2306. The intent validator accesses a stored set of intents 2308 and invokes a C→I/I→C component 2310 to translate the intents into corresponding configuration files 2312. Comparison logic 2314 within the intent validator then accesses configuration files from a virtual-network subsystem and compares them to the configuration files 2312 translated from the retrieved intents 2308. The intent validator generates a report indicating any inconsistencies between the retrieved and translated intents and the configuration files retrieved from the virtual-network subsystem. The report can be directly transmitted to a receiving entity 2316 or persistently stored 2318 for subsequent retrieval by a receiving entity.

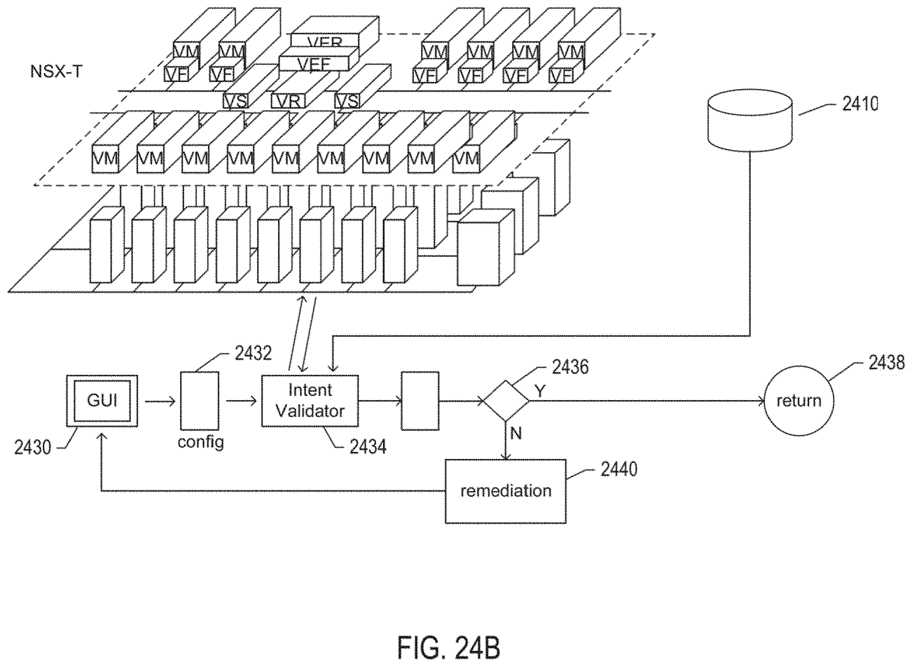

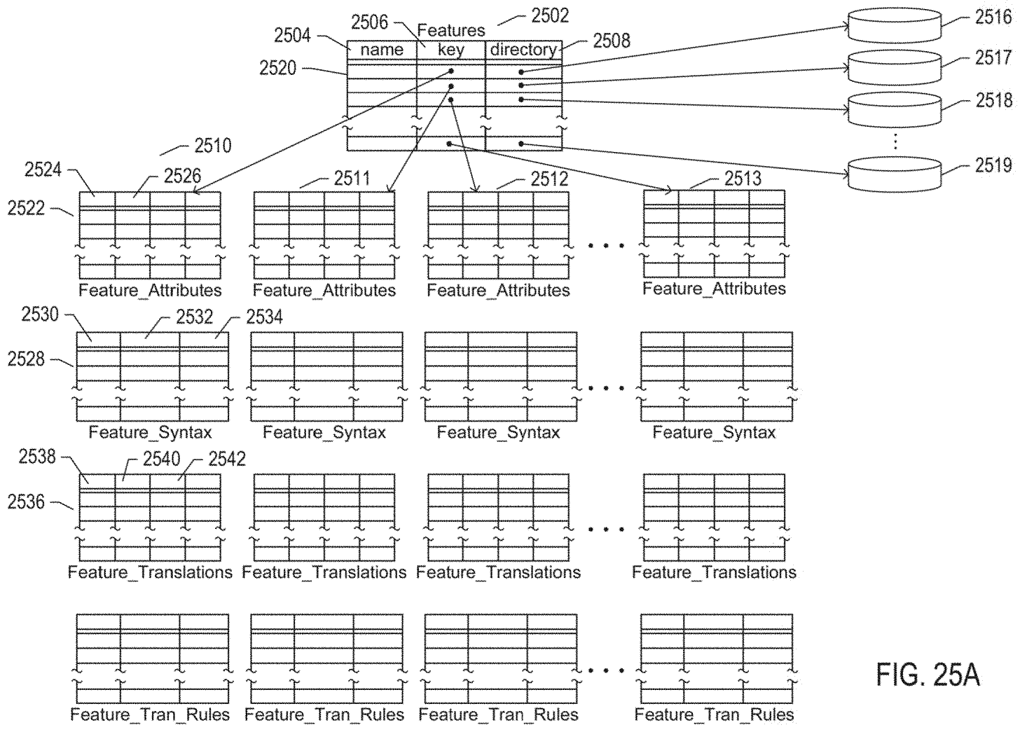

FIGS. 24A-B illustrates operation of the currently disclosed virtual-subsystem-migration validator. The virtual-subsystem-migration validator (“VSMV”) provides a GUI 2402 that accesses management-plane tools of an NSX-V virtual-network subsystem within a virtual distributed computer system 2404. Using user input and information obtained through the management-plane tools, the VSMV generates a config file 2406 that is input to an intent generator 2408 in order to generate and persistently store 2410 a set of intents that represent a full configuration for the NSX-V virtual-network subsystem. Then, either immediately or subsequently, a user interacts with the GUI 2412 provided by the VSMV to generate a second config file 2414 that controls an intent validator 2416 to retrieve the persistently stored intents 2410 and validate them against the NSX-V virtual-network-system configuration. When the retrieved intents accurately represent the NSX-V virtual-network-system configuration, as determined in a conditional step 2418, the migration coordinator 2420, discussed above with reference to FIGS. 19A-B, is launched to migrate the virtual-network subsystem within the virtual distributed computer system from NSX-V to NSX-T. Otherwise, the entire process is restarted, as indicated by arrow 2422. The validation performed by the intent validator 2416 ensures that the intents accurately reflect the current configuration and state of the NSX-V virtual-network-system.

Turning to FIG. 24B, once the migration process has completed, the VSMV again provides the GUI interface 2430, which a user uses to generate a third config file 2432 to direct and intent validator 2434 to retrieve the stored intents 2410 and compare them to a configuration obtained from the newly installed NSX-T virtual-network-system management plane. When the retrieved intents accurately reflect the configuration obtained from the newly installed NSX-T virtual-network-system management plane, as determined in conditional step 2436, then a successful-migration indication is returned 2438. Otherwise, a user is directed to undertake various manual, semi-automated, or automated remediation steps 2440 in order to place the newly installed NSX-T virtual-network subsystem in a state and current configuration that is consistent with the persistently stored intents generated from the configuration files obtained from the previously installed NSX-V virtual-network subsystem. Thus, the currently disclosed virtual-subsystem-migration validator, independently from the migration coordinator, ensures that a comprehensive set of configuration files obtained from a newly installed NSX-T virtual-network subsystem contain configuration information that is equivalent to the configuration information previously obtained from the previously installed NSX-V virtual-network subsystem. This provides a much higher level of confidence, to managers and administrators, that the migration process has successfully migrated the virtual-network subsystem from NSX-V to NSX-T and that any remaining problems and deficiencies following the migration process have been successfully and fully remediated. As discussed above, due to the enormous volume of configuration data and the complexities and the differences between the format, syntax, and vocabulary of NSX-V configuration data and NSX-T configuration data, the type and level of comprehensiveness of the validation performed by the currently disclosed VSMV cannot be performed manually by administrators and managers of a virtual distributed computer system, and without this level of validation, administrators and managers of many different types of virtual distributed computer systems cannot risk migration from NSX-V to NSX-T and are therefore left with increasingly out-of-date and increasingly poorly performing virtual distributed computer systems.

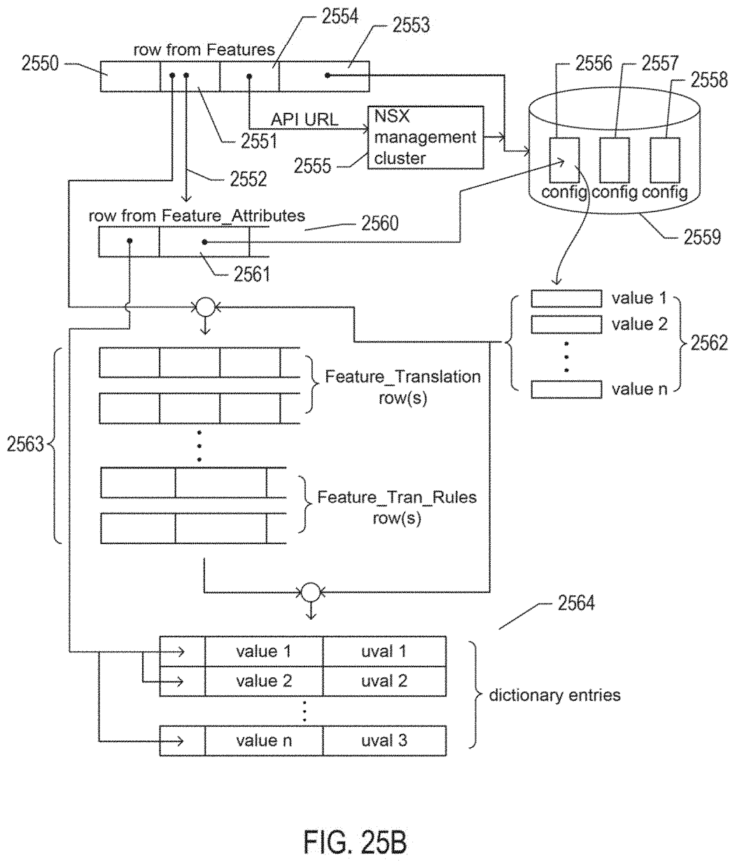

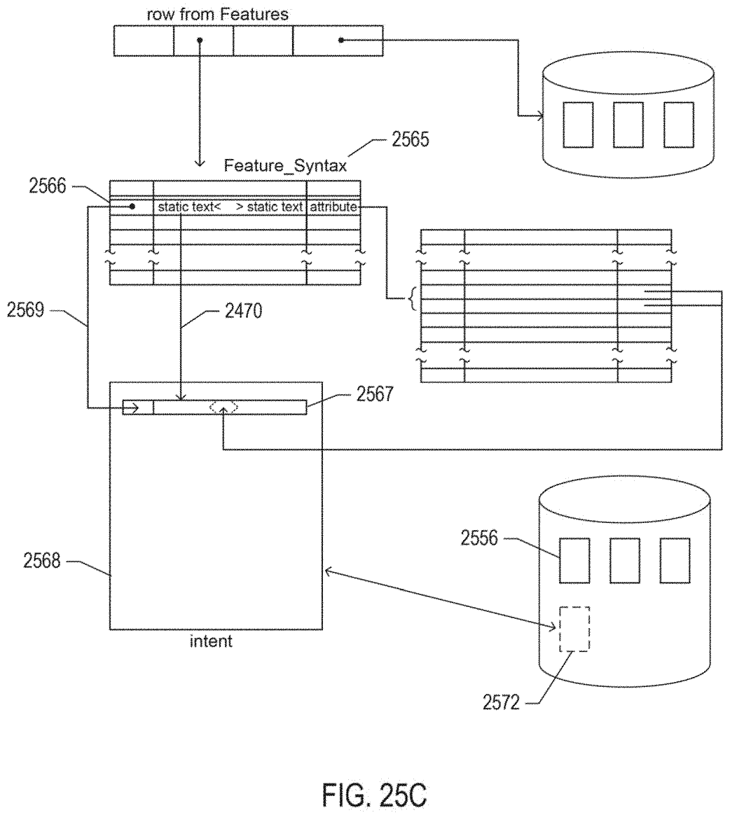

FIGS. 25A-C illustrates various relational-database tables that are used in one implementation of the currently disclosed methods and systems for converting configuration files to corresponding intents. These and similar relational-database tables are also used for the inverse operation of converting intents to configuration files. These tables are containing in a migration-validator database, in the implementation. FIGS. 25A-C are not intended to provide a full database schema, but to instead indicate the main tables and types of data stored in the tables used for configuration-file-to-intent conversions. The table Features 2502 provides a high-level partitioning of the stored data into sets of stored data that are each related to a particular feature, where features correspond to the types of virtual-network-subsystem entities, such as distributed firewalls, associated with configuration files. In a relational-database table, each row corresponds to an entry or record and each column corresponds to fields within each record. Each row, or entry, in the Features table corresponds to a different virtual-network-subsystem entity, or feature, and includes a name field 2504, a key field 2506, and a directory field 2508. The name field contains the name of the feature, such as the name “DFW” for a distributed-firewall feature, the key field includes an alphanumeric identifier used to identify additional relational-database tables containing information related to a feature and to the configuration-file-to-intent conversion for the feature, and the directory field contains a file-subsystem path to a directory in which configuration files and corresponding intents for the feature are stored. Thus, as shown in FIG. 25A, the key field in the entries of the Features table 2502 identify sets of additional relational-database tables associated with the feature represented by each row in the Features table, with the additional relational-database tables arranged, in FIG. 25A, in columns 2510-2513, one column for each different type of feature. The values in the directory field of the entries of the Features table reference file-system directories 2516-2519.

The additional relational-database tables in column 2510 associated with the feature represented by the first row 2520 in the Features table 2502 include: (1) the table Feature Attributes 2522, which includes an entry, or row, for each attribute of the feature and fields indicating the name of the attribute 2524 and indications of where values corresponding to the attribute are found in a configuration file 2526 describing an instance of the feature; (2) the table Feature Syntax 2528, which includes an entry for each line or statement in an intent for the feature, with fields indicating a first portion of the intent statement 2530, a second portion of the statement with placeholders for attribute values 2532, and a list of the attributes corresponding to the attribute-value placeholders 2534; (3) the table Feature_Translations 2536, which includes an entry for each attribute value in a configuration file for the feature that can be simply translated to a corresponding unified representation of the value used in an intent corresponding to configuration file and which includes fields containing the unified representation of the attribute value 2538, a representation for the attribute value in an NSX-V virtual-network subsystem 2840, and a representation for the attribute value in an NSX-T virtual-network subsystem 2842; and (4) Feature_Tran_Rules, which includes entries for feature attributes that require more complex translations from virtual-network-subsystem-specific representations to unified representations, and includes, for each feature attribute, a reference to a rule, set of rules, routine, or other type of translation entity that is applied to a value of the feature attribute extracted from a configuration file obtained from a particular type of virtual-network subsystem to translate the value to a corresponding unified value.

FIGS. 25B-C illustrate use of the data stored in the various relational-database tables discussed above with reference to FIG. 25A in order to convert a configuration file for a particular type of feature to a corresponding intent for the particular type of feature. The entry 2550 in the table Features (2502 in FIG. 25A) is retrieved from the table Features by using the name of the particular feature to identify the entry. The key field 2551 in the Features table entry 2550 is used to identify the Feature_Attributes table for the feature, as indicated by arrow 2552. The directory field 2553 in the Features table entry and an additional field 2554 in the Features table entry that contains a universal resource locator (“URL”) for the API of an NSX management cluster 2555 are used to extract one or more configuration files for instances of the feature from an NSX virtual-network subsystem and store the extracted configuration files 2556-2558 in the file-system directory 2559 for the particular type of feature. The configuration files are then translated to corresponding intents, which are also stored in the file-system directory 2559.

Translation of the first configuration file 2556 then proceeds as follows. Each row in the table Feature_Attributes is processed to translate feature-attribute values contained in the configuration into unified representations that are stored in a dictionary. For example, the values indicating where, in the configuration file, the values for the first attribute can be found, in the second field 2561 of the first row 2560 of the Feature_Attributes table are used to extract those values 2562 from the configuration file. In many cases, there will only be one value in the configuration file for a particular attribute, but, in other cases, there may be multiple values. The value in the key field 2551 of the Features table entry 2550 is used to identify the Feature_Translation and/or Feature_Tran_Rules tables for the particular feature and appropriate entries in one or both of these tables 2563 are then used to convert the extracted values 2562 into corresponding unified representations of the values. The extracted-value/unified-value pairs are then stored as entries in a dictionary 2564.

Once the dictionary is prepared by considering all of the attributes for the particular feature, the value in the key field 2551 of the Features table entry 2550 is used to identify the Feature_Syntax table 2565 for the particular feature. Each row, or entry, of the Feature_Syntax table, such as the first entry 2566, is then used to generate a corresponding line or statement 2567 in the intent 2568. The contents of the first two fields in entry 2566 of the Feature_Syntax table, as indicated by arrows 2569 and 2570, are used to generate the static portions of the line or statement 2567 and the placeholders in the static portion of the line or statement are replaced with unified values from the dictionary (2564 in FIG. 25B). Once all of the rows of the Feature_Syntax table been processed, the intent is stored 2572 in the directory for the particular feature in correspondence with the configuration file 2556 from which it was generated.

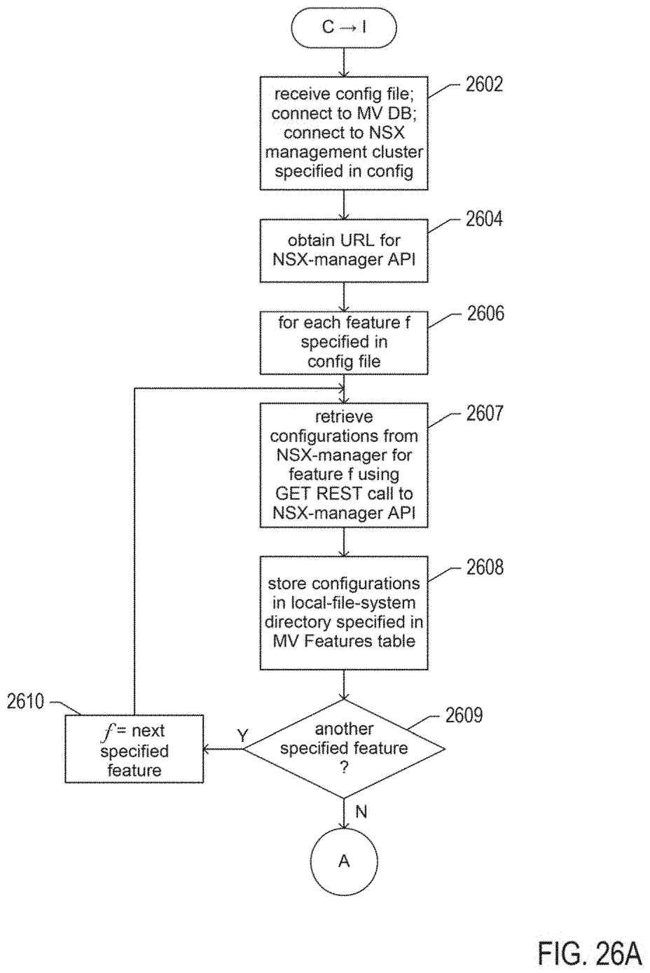

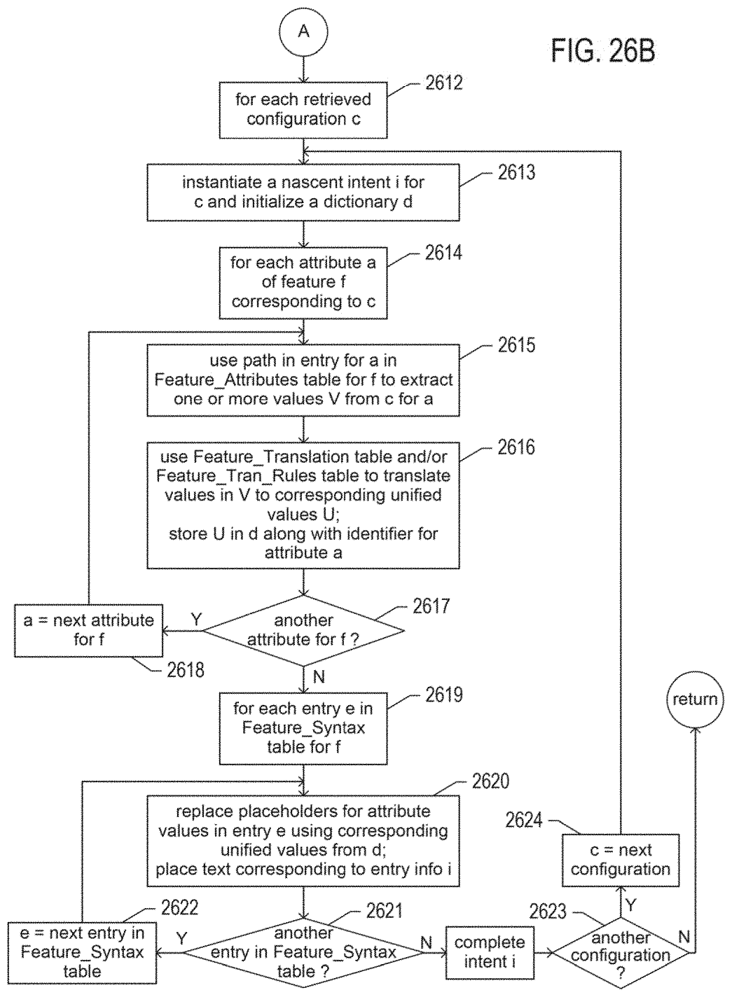

FIGS. 26A-B illustrates the configuration-to-intent conversion process carried out by the C→I/I→C component discussed above with reference to FIG. 21. In step 2602, the C→I/I→C component receives a config file that specifies parameters for the conversion, connects to a migration-validator database (“MV DB”), discussed above with reference to FIGS. 25A-C, and connects to the NSX management cluster from which configurations are to be extracted for conversion into corresponding intents. In step 2604, the URL for the API of the specified NSX manager is obtained from the Features table, as discussed above with reference to FIG. 25B. In the for-loop of steps 2606-2610, the configuration files corresponding to each feature f specified in the config file is extracted by calls to the API of the specified NSX management cluster and placed in the file-system directory for the feature. For each feature f, the configurations are obtained through the NSX-manager API using a REST GET request, in step 2607, and the configurations are stored in the file-system directory specified in the Features table, as discussed above with reference to FIG. 25A.

Turning to FIG. 26B, each configuration c extracted from the NSX management cluster is converted into a corresponding intent in the for-loop of steps 2612-2624. In step 2613, a nascent intent i for the currently considered configuration c is instantiated in the file directory for the feature corresponding to the configuration c and a dictionary d is initialized. In the inner for-loop of steps 2614-2618, each attribute a of the feature f corresponding to the currently considered configuration c is translated into one or more unified values and stored in the dictionary d, as discussed above with reference to FIG. 25B. In step 2615, values for the currently considered attribute a are extracted from the currently considered configuration file c using the indications in the second field of the entry for the currently considered attribute a in the Feature_Attributes table for feature f as discussed above with reference to FIG. 25B. Then, in step 2616, the extracted attribute values are translated into corresponding unified values using one or both of the Feature_Translation and Feature_Tran_Rules tables for feature f. Then, in the for-loop of steps 2619-2622, each entry e in the Feature_Syntax table for feature f is processed, as discussed above with reference to FIG. 25C, to generate a next line or statement in the intent i corresponding to the currently considered configuration file c. Following completion of the for-loop of steps 2619-2622, the intent i is completed. When there is another configuration to consider, as determined in step 2623, c is set to the next configuration, in step 2624, and control flows back to step 2613 for a next iteration of the for-loop of steps 2612-2624.

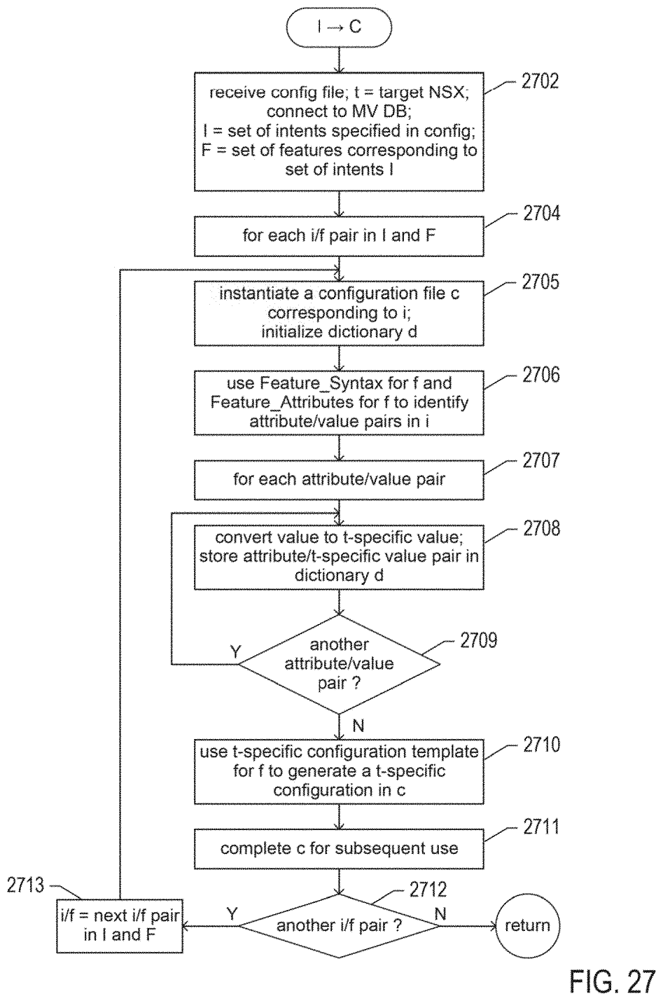

FIG. 27 illustrates the intent-to-configuration conversion process carried out by the C→I/I→C component discussed above with reference to FIG. 21. In step 2702, the C→I/I→C component receives a config file that specifies parameters for the conversion, sets a local variable t to the target NSX virtual-network-subsystem type, connects to a migration-validator database (“MV DB”), discussed above with reference to FIGS. 25A-C, initializes the set variable I to contain indications of the intents specified in the received config file, and initializes set variable F to contain the features corresponding to the intents contained in set variable I, where both set variables are ordered. In the for-loop of steps 2704-2713, each intent/feature pair in set variables I and F are considered. In step 2705, the configuration file c corresponding to the currently considered intent i is instantiated in the file-system directory for feature f and a dictionary d is initialized. In step 2706, the attribute/value pairs in currently considered intent i are identified using the Feature_Syntax and Feature_Attributes tables associated with feature f. In the inner for-loop of steps 2707-2709, all of the attribute values identified in intent i are converted to t-specific attribute-value representations and stored in the dictionary d. In step 2710, a t-specific configuration template for feature f is used to generate a t-specific configuration in configuration file c, using the dictionary d to replace attribute-value placeholders with t-specific attribute-value representations. In step 2711, the configuration file c is finished and stored for subsequent use.

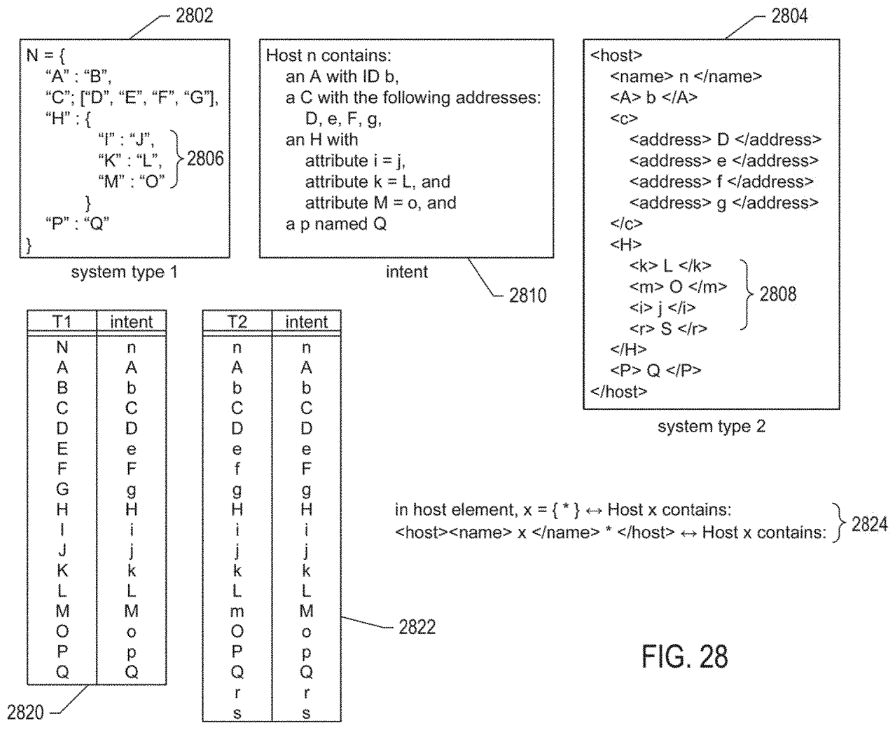

FIG. 28 illustrates differences between configuration files and intents. A small portion of a configuration file generated from a first implementation and/or version of a virtual subsystem is shown in a rectangle 2802. Uppercase letters represent alphanumeric terms and phrases. The same configuration information is included in a small portion of a configuration file generated from a second implementation and/or version of the virtual subsystem that is shown in rectangle 2804. Various differences between the two configuration files are immediately observed. The first configuration file 2802 uses a JSON-like format while the second configuration file 2804 uses an XML-like format. Various terms and phrases used in the first configuration file, such as the term or phrase represented by the symbol “B,” are replaced by different terms or phrases in the second configuration file, such as the term or phrase represented by the symbol “b” that corresponds to the term or phrase represented by the symbol “B” in the first configuration file. Furthermore, the order of an array of attributes 2806 in the first configuration file is changed in a corresponding list of attributes 2808 in the second configuration file and the list of attributes in the second configuration file contains an additional attribute not contained in the array of attributes in the first configuration file. The intent 2810 contains the same information as the first configuration file 2802 and almost the same information as the second configuration 2804, with the exception of the additional attribute in the attribute list 2808.

A set of configurations obtained from a virtual subsystem within a virtual distributed computer system corresponds to a set of intents generated from the same set of configurations or from a different set of configurations obtained from the same virtual subsystem or from a different version and/or implementation of the same virtual subsystem within the same virtual distributed computer system. However, the configuration information contained in a set of configurations may not be equivalent to the configuration information contained in a corresponding set on intents. For example, when a migration from NSX-V to NSX-T has not successfully completed, the configuration information represented by a set of configurations retrieved from the new NSX-T virtual subsystem may not be equivalent to the configuration information contained in a set of intents generated from configurations retrieved from the previously operating NSX-V virtual-network subsystem, as a result of which, as discussed above, the new NSX-T virtual subsystem may operate differently than the previous NSX-V virtual-network subsystem operated. Thus, the terms “correspond” and “equivalent” have different meanings when modifying “configuration” and/or intent in the context of the current discussion.

Of course, the full configuration for a virtual-network subsystem may include hundreds, thousands, tens of thousands, or more files and many megabytes of data. There may be many different types of differences between configuration files generated from two different implementations and versions of a virtual subsystem. Many different methods and techniques for translating a configuration file to an intent and from an intent to a configuration file are generally used. For example, tables 2820 and 2822 indicate that correspondences between terms and phrases used to represent feature-attribute values can be represented in correspondence tables. Translation rules, such as the simple translation rules 2824 shown in FIG. 28, can be used to convert various phrases and syntactic constructions in a configuration file to equivalent unified phrases and syntactic constructions in an intent, and vice versa. Regular expressions can be used for translation, as can be small translation routines. Additionally, machine-learning technologies can be employed to facilitate translations back and forth between terms and phrases used to represent feature-attribute values in configurations and unified terms and phrases used to represent feature-attribute values in intents. Many of the tools needed for these translations can be borrowed from sophisticated natural-language-processing systems.

The present invention has been described in terms of particular embodiments, it is not intended that the invention be limited to these embodiments. Modifications within the spirit of the invention will be apparent to those skilled in the art. For example, any of many different implementations of the virtual-subsystem-migration validator can be obtained by varying various design and implementation parameters, including modular organization, control structures, data structures, hardware, operating system, and virtualization layers, and other such design and implementation parameters. As discussed above, many different technologies and approaches can be applied to translation of configurations to intents and intents to configurations. In different implementations, the virtual-subsystem-migration validator may be interactive and semi-automated, while, in other implementations, the virtual-subsystem-migration validator may be fully automated. As discussed above, virtual-subsystem-migration validator can be implemented to validate migrations of a wide variety of different types of virtual subsystems, in addition to virtual-network subsystems and subsystem. a virtual-subsystem-migration validator can be implemented as an application that runs within a standalone computer system, as an application that runs within a virtual execution environment, as an application that runs within a distributed computer system, and as an application that runs within a virtual execution environment within a distributed computer system.

What is claimed is:

1. A virtual-sub system-migration validator comprising:
one or more processors;
one or more memories;
one or more data-storage devices; and
processor instructions, contained in executable files stored in one or more of the one or more data-storage devices, that when executed by one or more of the one or more processors, implement
a C-to-I/I-to-C component that translates configurations to intents and translates intents to configurations;
an intent generator that generates a set of intents that correspond to configurations retrieved from a virtual subsystem to a corresponding set of intents; and
an intent validator that retrieves a set of configurations from a virtual subsystem, compares the retrieved set of configurations to a corresponding set of intents, and generates an indication of whether or not the configuration information represents by the retrieved set of configurations is equivalent to the configuration information represented by the corresponding set of intents.

2. The virtual-subsystem-migration validator of claim 1 wherein the virtual-subsystem-migration validator validates a migration of a first virtual subsystem to a second virtual subsystem by:
directing the intent generator to generate a set of intents from a first set of configurations retrieved from the first virtual subsystem;
directing the intent validator to compare a second set of configurations retrieved from the first virtual subsystem to a third set of configurations regenerated from the set of intents;
when the second set of configurations is equivalent to the regenerated third set of configurations,
initiating migration from the first virtual subsystem to the second virtual subsystem, and
following completion of migration from the first virtual subsystem to the second virtual subsystem,
directing the intent validator to compare a fourth set of configurations retrieved from the second virtual subsystem to a fifth set of configurations regenerated from the set of intents, and
generating a validity indication when the fourth set of configurations is equivalent to the fifth set of configurations.

3. The virtual-subsystem-migration validator of claim 2 wherein, when the second set of configurations is equivalent to the regenerated third set of configurations, the virtual-subsystem-migration validator request and facilitates remediation of configuration differences before restarting migration validation.

4. The virtual-subsystem-migration validator of claim 2 wherein, following completion of migration from the first virtual subsystem to the second virtual subsystem, when the fourth set of configurations is not equivalent to the fifth set of configurations, the virtual-subsystem-migration validator generates an invalid indication along with a report that details differences between the fourth and fifth sets of configurations.

5. The virtual-subsystem-migration validator of claim 4 wherein, when the fourth set of configurations is not equivalent to the fifth set of configurations, the virtual-subsystem-migration validator additionally requests and facilitates remediation of configuration differences.

6. The virtual-subsystem-migration validator of claim 2 wherein the C-to-I/I-to-C component translates configurations to intents and intents to configurations using one or more of:
term-and-phrase translation table;
regular expressions;
translation rules;
translation routines; and
machine-learning systems.

7. The virtual-subsystem-migration validator of claim 2 wherein the virtual subsystem is a virtual-network subsystem.

8. The virtual-subsystem-migration validator of claim 7
wherein first virtual subsystem is an NSX-V virtual-network subsystem; and
wherein the second virtual subsystem is an NSX-T virtual-network subsystem.

9. The virtual-subsystem-migration of claim 8 wherein the sets of configurations:
a description of a virtual-network topology, including locations and interconnections of virtual local-area networks (“vLANs”) and locations and connections between virtual-network elements, including virtual switches, virtual routers, virtual edge routers, virtual firewalls, and virtual private networks (“vVPNs);
firewall policies and rules for the virtual firewalls;
routing tables;
address-translation tables;
IP-address tables;
domain-name-to-IP-address tables;
media-access-control (“MAC”) address tables;
address-resolution-protocol (“ARP”) tables;
virtual tunnel endpoint (“VTEP”) tables; and
encryption keys and host certificates.

10. A method that validates a migration of a first virtual subsystem to a second virtual subsystem, the method comprising:
generating a set of intents from a first set of configurations retrieved from the first virtual subsystem;
comparing a second set of configurations retrieved from the first virtual subsystem to a third set of configurations regenerated from the set of intents;
when the second set of configurations is equivalent to the regenerated third set of configurations,
initiating migration from the first virtual subsystem to the second virtual subsystem, and
following completion of migration from the first virtual subsystem to the second virtual subsystem,
comparing a fourth set of configurations retrieved from the second virtual subsystem to a fifth set of configurations regenerated from the set of intents, and
generating a validity indication when the fourth set of configurations is equivalent to the fifth set of configurations.

11. The method of claim 10 carried out by a virtual-subsystem-migration validator comprising:
one or more processors;
one or more memories;
one or more data-storage devices; and
processor instructions, contained in executable files stored in one or more of the one or more data-storage devices, that when executed by one or more of the one or more processors, implement
a C-to-I/I-to-C component that translates configurations to intents and translates intents to configurations;
an intent generator that generates a set of intents that correspond to configurations retrieved from a virtual subsystem to a corresponding set of intents; and
an intent validator that retrieves a set of configurations from a virtual subsystem, compares the retrieved set of configurations to a corresponding set of intents, and generates an indication of whether or not the configuration information represents by the retrieved set of configurations is equivalent to the configuration information represented by the corresponding set of intents.

12. The method of claim 10 further comprising:
when the second set of configurations is equivalent to the regenerated third set of configurations, requesting and facilitating remediation of configuration differences before restarting migration validation.

13. The method of claim 10 further comprising:
following completion of migration from the first virtual subsystem to the second virtual subsystem, when the fourth set of configurations is not equivalent to the fifth set of configurations, the virtual-subsystem-migration validator generates an invalid indication along with a report that details differences between the fourth and fifth sets of configurations.

14. The method system of claim 10 wherein, when the fourth set of configurations is not equivalent to the fifth set of configurations, the virtual-subsystem-migration validator additionally requests and facilitates remediation of configuration differences.

15. The method of claim 10 wherein configurations are translated to intents and intents are translated to configurations using one or more of:
term-and-phrase translation table;
regular expressions;
translation rules;
translation routines; and
machine-learning systems.

16. The method of claim 10 wherein the virtual subsystem is a virtual-network subsystem.

17. The method of claim 16
wherein first virtual subsystem is an NSX-V virtual-network subsystem; and
wherein the second virtual subsystem is an NSX-T virtual-network subsystem.

18. The method of claim 17 wherein the sets of configurations include:
a description of a virtual-network topology, including locations and interconnections of virtual local-area networks (“vLANs”) and locations and connections between virtual-network elements, including virtual switches, virtual routers, virtual edge routers, virtual firewalls, and virtual private networks (“vVPNs);
firewall policies and rules for the virtual firewalls;
routing tables;
address-translation tables;
IP-address tables;
domain-name-to-IP-address tables;
media-access-control (“MAC”) address tables;
address-resolution-protocol (“ARP”) tables;
virtual tunnel endpoint (“VTEP”) tables; and
encryption keys and host certificates.

19. A physical data-storage device that stores computer instructions that, when executed by processors within computer system, control the computer system to:
generate a set of intents from a first set of configurations retrieved from the first virtual sub system;
compare a second set of configurations retrieved from the first virtual subsystem to a third set of configurations regenerated from the set of intents;
when the second set of configurations is equivalent to the regenerated third set of configurations,
initiate migration from the first virtual subsystem to the second virtual subsystem, and
following completion of migration from the first virtual subsystem to the second virtual subsystem,
compare a fourth set of configurations retrieved from the second virtual subsystem to a fifth set of configurations regenerated from the set of intents, and
generate a validity indication when the fourth set of configurations is equivalent to the fifth set of configurations.

20. The physical data-storage device of claim 19 wherein the computer instructions, when executed by processors within computer system, control the computer system to implement a virtual-sub system-migration validator comprising:
one or more processors;
one or more memories;
one or more data-storage devices; and
processor instructions, contained in executable files stored in one or more of the one or more data-storage devices, that when executed by one or more of the one or more processors, implement
a C-to-I/I-to-C component that translates configurations to intents and translates intents to configurations;
an intent generator that generates a set of intents that correspond to configurations retrieved from a virtual subsystem to a corresponding set of intents; and
an intent validator that retrieves a set of configurations from a virtual subsystem, compares the retrieved set of configurations to a corresponding set of intents, and generates an indication of whether or not the configuration information represents by the retrieved set of configurations is equivalent to the configuration information represented by the corresponding set of intents.
